(19) United States
(12) Patent Application Publication
(10) Pub. No.: US 2026/0242889 A1
(43) Pub. Date: Aug. 20, 2026

(54) PLANT-BASED METAL RECOVERY PLATFORM

(71) Applicant: PIMIRS Technologies, LLC, Dallas, TX (US)

(72) Inventors: Glenn Wesley Bedell, Las Cruces, NM (US); Richard Guadalupe McDonald, Las Cruces, NM (US)

(21) Appl. No.: 19/542,003

(22) Filed: Feb. 17, 2026

Related U.S. Application Data
(60) Provisional application No. 63/759,660, filed on Feb. 18, 2025.

(51) Int. Cl. C22B 3/18; B09C 1/10; C02F 3/32; C02F 101/20; C22B 59/00

(52) U.S. Cl. CPC C22B 3/18; C22B 59/00; B09C 1/10; C02F 3/322; C02F 2101/20

(57) ABSTRACT

Disclosed herein are compositions, methods, and systems for selective metal recovery using a biologically derived reductant. This process enables the rapid generation of substantially single-metal, single-metal oxides, or single-metal hydroxide crystals, depending on the metal, from ions in solution, achieving high efficiency at ambient temperature and pressure. The system produces large, stress-free crystals across a range of sizes, with potential for further expansion in low-gravity environments. Waste byproducts from the Plant Induced Metal Ion Reductants (PIMIRS) growth phases can be repurposed to rejuvenate degraded soils, providing a sustainable solution for soil enhancement. The growth of PIMIRS is maintained at a low pH to prevent microbial contamination without the need for toxic additives, with carefully controlled temperature conditions across phases, and operates effectively in low-salinity environments. This approach offers an efficient and environmentally responsible method for high-yield metal recovery and soil enhancement.

### RELATED APPLICATION

Under provisions of 35 U.S.C. § 119(e), the Applicant claims benefit of U.S. Provisional Application No. 63/759,660 filed on Feb. 18, 2025, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF INVENTION

The present invention relates to compositions, formulations, materials, agents, systems, and methods for the recovery of metal using biological materials, more specifically, biological materials derived from algae.

### BACKGROUND OF THE INVENTION

Previous approaches for the recovery of metals, such as rare earth elements (REEs), from aqueous solutions have typically involved complex and energy-intensive processes such as solvent extraction, ion exchange, and precipitation methods. These conventional methods often suffer from low selectivity, high cost, and environmental concerns due to the generation of large amounts of waste and the use of hazardous chemicals. Additionally, these methods may not be efficient in selectively targeting REEs, leading to lower overall recovery rates and increased processing times.

For example, traditional methods may result in incomplete recovery of valuable metals or the recovery of metals in forms that are not optimal for specific industrial applications. Additionally, these methods may involve the use of harsh chemicals or conditions that can be detrimental to the environment, or the structural integrity of the materials involved. Therefore, there may be a need for a method that enhances the selectivity and efficiency of metal recovery while also being mindful of environmental impact and material integrity. The use of harsh chemicals and unfavorable conditions in traditional metal recovery processes may lead to environmental degradation and compromise the structural integrity of the materials involved. The process of metal recovery often requires the handling of toxic substances and exposure to extreme conditions, which may not only pose risks to human health but also to the surrounding ecosystem. The inefficiencies in these conventional methods may result in the incomplete recovery of valuable metals, which can lead to economic losses and increased waste. Furthermore, the recovery of metals in forms that are not ideally suited for specific industrial applications may require additional processing steps, thereby increasing operational costs and energy consumption.

Some prior art has explored the use of biological materials, such as algae, for the recovery of REEs from aqueous solutions. Algae are known for their high affinity to metal ions, including REEs, due to the presence of various functional groups on their cell walls that can selectively bind to specific metal ions. However, existing approaches utilizing algae-based materials for REE recovery have faced challenges in achieving high selectivity and efficiency, including not generating metal crystals in situ, as well as in optimizing the reduction environment for the targeted REEs.

Some existing techniques for metal recovery from algal biomass have focused on physical methods such as filtration or centrifugation to separate the metal-loaded algal biomass from the desorption reagents. While these methods can reduce the reliance on chemical reagents, they may still require additional processing steps to achieve high purity metal recovery. Furthermore, the efficiency of metal recovery using physical separation methods may be limited by the size and morphology of the algal cells or cell fragments, leading to incomplete metal extraction and lower yields of recovered metal crystals.

Other approaches in the field of metal recovery from algal biomass have explored the use of biological processes or microbial interactions to facilitate metal binding and release from algal cells. While these methods offer potential advantages in terms of sustainability and environmental impact, they may still require the addition of external stimuli or microbial agents to achieve efficient metal recovery as these do not generate metal crystals in situ. Moreover, the reliance on biological processes can introduce variability and complexity into the metal recovery process, making it challenging to control the quality and quantity of the recovered metal ions to reduce into metal crystals.

In certain instances, chelating agents have been incorporated into formulations for metal ion recovery to enhance the selectivity and binding affinity of the biological material towards specific metal ions. These chelating agents can form stable complexes with the target metal ions, thereby facilitating their extraction and separation from the aqueous solution. However, the selection and optimization of chelating agents for REE recovery using algae-based materials have not been fully addressed in the prior art. Moreover, the importance of pH adjustment in creating an optimal reduction environment for REEs during the recovery process has been recognized, but existing methods may lack specificity and efficiency in this regard. These challenges highlight the limitations in current methodologies and underscore the necessity for developments that could address these inefficiencies and environmental concerns. However, none of these approaches has provided a comprehensive solution that combines the features described in this disclosure.

### SUMMARY OF THE INVENTION

In accordance with the purposes of the invention, as embodied and broadly described herein, the present invention, in one aspect, relates to compositions, formulations, materials, agents, systems, and methods for the recovery of pure, single-metal crystals, metal-oxide crystals, or metal-hydroxide crystals using biological materials, such as, for example, rare earth elements (REEs) and noble metals, using biological materials derived from algae.

In some aspects, the present invention relates to a formulation of Plant Induced Metal Ion Reductants (PIMIRS) designed for the selective recovery of rare earth elements, noble metals and other metals from aqueous solutions. The formulation may include a base composition derived from algae with a high affinity for REEs. This innovative formulation for the reduction of metal ions to pure, single-metal crystals, metal-oxide crystals, or metal-hydroxide crystals offers an efficient and environmentally friendly method for the extraction of REEs and other metals, addressing the growing demand for sustainable rare earth element and noble-metal recovery processes.

In some aspects, the techniques described herein relate to a composition for selective metal recovery including a material derived from the living or dead cells or cell fragments of an alga, or the surface layer of living or dead cells of an alga; wherein the metal is recovered in the form of pure, single-metal crystals, or metal-oxide crystals, or metal-hydroxide crystals, which are initially adsorbed to the said living or dead cells or cell fragments or surface layer of living or dead cells, and which are eventually naturally desorbed from said living or dead cells or cell fragments, or surface layer of living or dead cells, without the use of a desorption reagent, once the said crystals reach some critical size.

In some aspects, the techniques described herein relate to a formulation of PIMIRS for the selective recovery of metals, including: a base composition derived from algae known for high affinity to REEs. In some embodiments, a formulation may optionally comprise additional components such as, and without limitation, specific chelating agents added to enhance the selectivity for REEs; and/or pH adjusters to optimize the reduction environment for REEs.

In some aspects, the techniques described herein relate to a composition for the selective recovery of metals, including: algae extracts specifically processed to maximize the surface area and adsorption sites for precious metals; additives that stabilize the PIMIRS in solutions with high metal-ion concentrations; buffering agents to maintain the solution at an optimal pH for precious metal recovery.

In some aspects, the techniques described herein relate to a formulation of PIMIRS configured for the efficient recovery of transition metals from industrial waste streams, including: a base extract from a selected species of algae known for its high affinity to transition metals; in some embodiments, formulations may include blend of natural chelators that enhance the binding efficiency of PIMIRS to transition metals; and/or pH modifiers to optimize the reaction environment for maximum metal precipitation.

In some aspects, the techniques described herein relate to a formulation for the selective extraction of heavy metals from contaminated soil and water, including: algae-derived bioactive compounds tailored to bind specifically with heavy metals; soil and water conditioners that facilitate the mobilization of heavy metals towards the bioactive sites of PIMIRS.

In some aspects, the techniques described herein relate to a formulation designed for multi-metal recovery, capable of selectively recovering different metals from a mixed metal solution, including: a base composition that includes a blend of plant extracts each having a selective affinity for different metal ions; modifiers that adjust the reactivity of the PIMIRS based on the ionic composition of the solution.

In some aspects, the techniques described herein relate to a formulation designed for selective adsorption and collection of specific types of metal ores, including: a base composition of plant extracts tailored to target specific metal ions; additives that enhance the specificity and binding strength of PIMIRS to the desired metal ores, reducing by-catch of non-target metals.

In some aspects, the techniques described herein relate to a formulation characterized by enhanced electron transfer capabilities for rapid metal-ion reduction, including: the waste growth material from growing order Cyanidiales, such as genus Galdieria, for example, and without limitation, Galdieria sulphuraria, to optimize the pH in soil.

In some aspects, the techniques described herein relate to any disclosed formulation or composition, wherein the formulation or composition selectively recovers one or more noble metals and/or one or more transition metals and/or one or more REEs.

In some aspects, the techniques described herein relate to a method for recovering metal, including: an addition step of adding a material derived from the living or dead cells or cell fragments of an alga, or the surface layer of living or dead cells of an alga, to a metal solution; and a recovery step of recovering a metal from the metal solution by the material derived from the living or dead cells or cell fragments of an alga, or the surface layer of living or dead cells of an alga; wherein the metal is recovered in the form of pure, single-metal crystals, or metal-oxide crystals, or metal-hydroxide crystals, which are initially adsorbed to the said living or dead cells or cell fragments of an alga, or the said surface layer of living or dead cells of an alga, and which are eventually naturally desorbed from said living or dead cells or cell fragments of an alga, or the said surface layer of living or dead cells of an alga, without the use of a desorption reagent, once the said crystals reaches some critical size.

In some aspects, the techniques described herein relate to a method for reducing metal ions to pure, single-metal crystals, or metal-oxide crystals, or metal-hydroxide crystals using PIMIRS, including: providing a solution containing metal ions; Adding PIMIRS to the solution; adjusting the pH of the solution to facilitate the reduction of metal ions; allowing the metal ions to reduce to pure, single-metal crystals, or metal-oxide crystals, or metal-hydroxide crystals; separating the pure, single-metal crystals, or metal-oxide crystals, or metal-hydroxide crystals from the solution.

In some aspects, the techniques described herein relate to a method for preparing a metal ion reductant from algae, including: cultivating a specified algae species known to contain metal-reducing properties; harvesting the cultivated algae at a growth stage optimized for metal ion reduction capabilities; processing the harvested algae to extract cell walls and membranes while preserving their metal-reducing properties; formulating the treated extracts into a composition suitable for use as a metal ion reductant in aqueous solutions.

In some aspects, the techniques described herein relate to a method for reducing metal ions in a solution using PIMIRS, including: Introducing PIMIRS into an aqueous solution containing one or more types of metal ions; adjusting the pH of the solution to a level optimal for the reduction of the metal ions by the PIMIRS; maintaining the solution under conditions favorable for the interaction between the metal ions and PIMIRS, leading to the reduction of the metal ions to pure, single-metal crystals, or metal-oxide crystals, or metal-hydroxide crystals; separating the pure, single-metal crystals, or metal-oxide crystals, or metal-hydroxide crystals from the solution.

In some aspects, the techniques described herein relate to a method for reducing metal ions to pure, single-metal crystals, or metal-oxide crystals, or metal-hydroxide crystals using a biologically derived reductant, including: providing an aqueous solution containing metal ions; Introducing a biologically derived reductant, specifically PIMIRS, into the solution; adjusting and maintaining the pH of the solution to optimize the reduction of metal ions by the PIMIRS; allowing the metal ions to react with the PIMIRS under controlled conditions to form pure, single-metal crystals, or metal-oxide crystals, or metal-hydroxide crystals; collecting the pure, single-metal crystals, or metal-oxide crystals, or metal-hydroxide crystals formed as a result of the reduction process.

In some aspects, the techniques described herein relate to a method for rapidly reducing metal ions in a solution, including: introducing a biologically derived reductant, specifically PIMIRS, into an aqueous solution containing metal ions; adjusting the pH of the solution to a predetermined level that facilitates rapid reduction of the metal ions; allowing the metal ions to react with the PIMIRS to form pure, single-metal crystals, or metal-oxide crystals, or metal-hydroxide crystals within 24 hours.

In some aspects, the techniques described herein relate to a method for producing high-purity pure, single-metal crystals, or metal-oxide crystals, or metal-hydroxide crystals using PIMIRS, including: introducing PIMIRS into an aqueous solution containing metal ions; adjusting the pH of the solution to optimize the reduction of metal ions to pure, single-metal crystals, or metal-oxide crystals, or metal-hydroxide crystals; allowing the metal ions to react with the PIMIRS under controlled conditions to form high-purity, single-metal crystals, or metal-oxide crystals, or metal-hydroxide crystals.

In some aspects, the techniques described herein relate to a method for enhancing the purity of single-metal crystals, or metal-oxide crystals, or metal-hydroxide crystals formed in a metal reduction process, including: providing an aqueous solution of mixed metal ions; Adding PIMIRS specifically prepared from Galdieria sulphuraria to the solution; controlling environmental factors including pH and temperature to facilitate the formation of high-purity, single-metal crystals, or metal-oxide crystals, or metal-hydroxide crystals.

In some aspects, the techniques described herein relate to a method for selectively precipitating specific metal ions from a mixed metal ion solution using PIMIRS, including: introducing PIMIRS into an aqueous solution containing a mixture of different metal ions; adjusting the pH of the solution to a level that selectively facilitates the reduction of desired metal ions to pure, single-metal crystals, or metal-oxide crystals, or metal-hydroxide crystals; allowing the reaction to proceed under controlled conditions until the desired metal ions are selectively precipitated.

In some aspects, the techniques described herein relate to a method for enhancing the selectivity of metal ion precipitation in a reduction process using PIMIRS, including: providing a solution with mixed metal ions; Adding PIMIRS formulated to selectively bind with specific metal ions; controlling process parameters including pH, temperature, and PIMIRS concentration to maximize the selective precipitation of targeted metal ions.

In some aspects, the techniques described herein relate to a method for reducing metal ions using PIMIRS with minimized processing steps, including: introducing PIMIRS directly into an aqueous solution containing metal ions without prior treatment of the solution; adjusting the pH of the solution to facilitate rapid reduction of metal ions pure, single-metal crystals, or metal-oxide crystals, or metal-hydroxide crystals; allowing the reaction to proceed under conditions that do not require intermittent adjustments or additional processing agents.

In some aspects, the techniques described herein relate to a method for enhancing resource efficiency in a metal ion reduction process using PIMIRS, including: utilizing PIMIRS derived from sustainably sourced algae; conducting the metal reduction process under optimized conditions that minimize the use of additional chemicals and energy; recycling the PIMIRS for multiple cycles of metal ion reduction to maximize their usage and reduce waste, including the utilization of wastewater from PIMIRS growth media to condition soil.

In some aspects, the techniques described herein relate to a method for extracting PIMIRS from algae, including: cultivating algae known for their metal ion reduction capabilities; harvesting the algae and subjecting it to a cell disruption process to release cellular components; extracting the PIMIRS from the disrupted cell mixture using a solvent extraction process; purifying the extracted PIMIRS to remove impurities and concentrate the active components.

In some aspects, the techniques described herein relate to a method for preparing PIMIRS for use in metal ion reduction, including: selecting a specific species of algae known for its metal ion reduction properties; cultivating the selected algae under conditions optimized for the production of metal-binding compounds; harvesting the algae and processing it to extract the active metal ion reductant components; formulating the extracted components into a stable PIMIRS product suitable for introduction into metal ion solutions.

In some aspects, the techniques described herein relate to a method for preparing PIMIRS with improved structural attributes for efficient metal ion reduction, including: processing Galdieria sulphuraria to retain integral cell wall components that maximize surface area and provide multiple active sites for metal binding.

In some aspects, the techniques described herein relate to a method for scaling up the production of PIMIRS for industrial applications, including: establishing large-scale cultivation facilities for algae known for their metal ion reduction capabilities; implementing automated harvesting and processing systems to extract and formulate PIMIRS; integrating continuous flow systems for the seamless production and application of PIMIRS in metal recovery processes.

In some aspects, the techniques described herein relate to a method for automating the production and application of PIMIRS, including: implementing a computer-controlled system to manage the cultivation, extraction, and application phases of PIMIRS; utilizing sensors and feedback mechanisms to monitor critical parameters such as pH, temperature, and metal ion concentration in real-time; adjusting process variables automatically based on data received from the monitoring systems to optimize the efficiency and effectiveness of PIMIRS.

In some aspects, the techniques described herein relate to a method for recycling PIMIRS in a continuous metal reduction system, including: implementing a cyclic system where PIMIRS are alternately used for metal reduction and regenerated in a continuous loop; monitoring the efficacy of PIMIRS in each cycle and adjusting the regeneration process parameters to optimize performance.

In some aspects, the techniques described herein relate to a method for reducing operational costs in metal ion reduction processes using PIMIRS, including: utilizing PIMIRS derived from cost-effective, rapidly renewable algae sources; implementing a simplified process flow that reduces the need for additional chemicals and complex machinery; recycling and reusing PIMIRS to extend their operational life and reduce material costs.

In some aspects, the techniques described herein relate to a method for reducing the environmental impact of metal ion reduction processes using PIMIRS, including: employing PIMIRS derived from environmentally sustainable algae sources; conducting the metal reduction process in a manner that minimizes the release of harmful by-products; implementing a waste recycling strategy to reuse or safely dispose of waste materials generated during the process.

In some aspects, the techniques described herein relate to a method for enhancing safety and reducing environmental impact and release of volatile organic compounds (VOCs) and other hazardous materials during mining operations (i.e., explosives and blasting agents, processing chemicals, diesel emissions, and natural sources).

In some aspects, the techniques described herein relate to a method for recycling and reusing PIMIRS in metal recovery processes, including: collecting spent PIMIRS after metal recovery operations; Treating the spent PIMIRS to remove impurities and regenerate active metal-reducing components; reintroducing the regenerated PIMIRS into the metal recovery process.

In some aspects, the techniques described herein relate to a method for applying PIMIRS in industrial metal recovery processes, including: introducing PIMIRS into a metal-laden aqueous solution under controlled flow conditions; monitoring the reduction process in real-time using sensors to detect metal ion concentrations; adjusting the dosage of PIMIRS dynamically based on sensor feedback to optimize metal recovery efficiency.

In some aspects, the techniques described herein relate to a method for preparing PIMIRS for use in metal recovery, including: cultivating Galdieria sulphuraria under controlled conditions to achieve optimal biomass; harvesting the biomass and extracting cell wall components known for their metal-binding properties; treating the extracted components with a stabilization agent to enhance their shelf-life and electron transfer capabilities.

In some aspects, the techniques described herein relate to a method for recovering metals using PIMIRS, including: introducing PIMIRS into a solution containing dissolved metal ions; adjusting the pH of the solution to optimize the reduction potential of the metal ions; allowing sufficient time for PIMIRS to bind and reduce the metal ions to their elemental or oxide forms; separating the metal-loaded PIMIRS from the solution; recovering the metals from PIMIRS through a gentle desorption process that preserves the integrity of both the metals and PIMIRS.

In some aspects, the techniques described herein relate to a method for immobilizing PIMIRS onto a solid support, including: selecting a solid support material that is compatible with PIMIRS and the target metal recovery environment; coating or attaching PIMIRS onto the solid support using a binding agent that ensures stability and maintains the functionality of PIMIRS; conditioning the immobilized PIMIRS to optimize their metal-binding properties prior to use in metal recovery.

In some aspects, the techniques described herein relate to a method for storing PIMIRS formulations designed to enhance stability and prolong shelf life, including: storing the PIMIRS in airtight containers made from materials that do not react with the formulation components.

In some aspects, the techniques described herein relate to a system for rapid metal ion reduction, including: a reaction vessel configured to contain an aqueous solution of metal ions; a delivery system for introducing PIMIRS into the reaction vessel; a pH control system designed to adjust and maintain the pH of the solution at an optimal level for rapid metal ion reduction; a separation unit for isolating pure, single-metal crystals, or metal-oxide crystals, or metal-hydroxide crystals from the solution post-reaction.

In some aspects, the techniques described herein relate to a system for cost-effective metal ion reduction, including: a reaction vessel equipped with PIMIRS; a control system designed to optimize the use of PIMIRS and minimize waste; a recovery and regeneration module for PIMIRS to facilitate their reuse in subsequent reduction cycles.

In some aspects, the techniques described herein relate to a system for efficient metal ion reduction, including: a reaction vessel configured to receive an aqueous solution and PIMIRS; a pH adjustment mechanism that automatically sets and maintains the optimal pH for metal ion reduction; a single-step separation unit designed to isolate high-purity, single-metal crystals, or metal-oxide crystals, or metal-hydroxide crystals from the reaction mixture without multiple washing or purification stages.

In some aspects, the techniques described herein relate to a system for environmentally friendly metal ion reduction, including: a reaction vessel designed to minimize energy consumption; a control system programmed to optimize the use of PIMIRS and reduce waste; a treatment unit for purifying and recycling water and other resources used in the metal reduction process.

In some aspects, the techniques described herein relate to a PIMIRS system designed for automated adaptation to varying metal ion concentrations in industrial effluents, including: sensor arrays that detect changes in metal ion concentrations in real-time; a control unit programmed to adjust the PIMIRS dosage automatically based on the sensor data to maintain optimal metal recovery efficiency.

In some aspects, the techniques described herein relate to a system for the integrated application of PIMIRS in industrial settings, including: a dosing unit that automatically administers PIMIRS into processing streams; a monitoring unit equipped with sensors for real-time analysis of metal ion reduction; a control unit that processes data from the monitoring unit and adjusts the PIMIRS dosing rate accordingly.

In some aspects, the techniques described herein relate to a system for the production of PIMIRS from algae, including: a cultivation unit for growing algae under controlled conditions; a disruption unit designed to mechanically or chemically break down algae cells; An extraction unit that uses solvents to isolate PIMIRS from the cell debris; a purification system that refines the PIMIRS extract to achieve high purity and functionality.

In some aspects, the techniques described herein relate to a system for preparing PIMIRS from algae, including: a cultivation module designed to grow algae in an optimized nutrient environment; a processing unit for extracting and isolating active components from the algae; a formulation unit that combines the active components with stabilizers and carriers to produce a ready-to-use PIMIRS product; a quality control module to ensure the consistency and efficacy of the PIMIRS product.

In some aspects, the techniques described herein relate to a system for large-scale industrial application of PIMIRS, including: a modular cultivation unit scalable according to production needs; a high-capacity processing unit equipped with advanced extraction and formulation technologies; an application unit designed for efficient integration of PIMIRS into various industrial metal recovery setups.

In some aspects, the techniques described herein relate to a system for optimized process control in the production and use of PIMIRS, including: a central control unit equipped with software capable of processing input from multiple sensors and executing control actions; an array of sensors distributed throughout the cultivation, extraction, and application units to continuously gather data; actuators linked to the control unit to adjust environmental conditions and process flows automatically.

In some aspects, the techniques described herein relate to a system for the sustainable management of PIMIRS, including: a collection unit designed to efficiently gather spent PIMIRS from industrial processes; a regeneration unit equipped with filtration, chemical treatment, and reactivation facilities to restore the efficacy of PIMIRS; a feedback mechanism that reintroduces regenerated PIMIRS into the production cycle, minimizing waste and reducing the need for fresh PIMIRS production.

In some aspects, the techniques described herein relate to an article of manufacture including pure, single-metal crystals, or metal-oxide crystals, or metal-hydroxide crystals produced by the reduction of metal ions using PIMIRS.

In some aspects, the techniques described herein also related to systems and methods for producing hydrogen using a disclosed composition or formulation. For example, in one aspect, method for producing hydrogen may comprise using PIMIRS, including the steps: preparing an aqueous solution containing a Group 1 or Group 2 element; modifying the pH of the aqueous solution; introducing PIMIRS into the aqueous solution; inducing precipitation of a hydroxide of the Group 1 or Group 2 element; and producing hydrogen gas as a result of the precipitation.

To this end, various aspects and embodiments of the present invention may be referred to herein as a composition, formulation, material, agent, article, system, and/or method for recovery of metals, and may also be described or referred to collectively as the ‘platform’, and individually as a product, system, means, or agent named PIMIRS™, or other such designation determined by the applicant. Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate several aspects of the invention and together with the description, serve to explain the principles of the invention. The drawings may contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. Applicant retains and reserves all rights in its trademarks and copyrights included herein, and grants permission to reproduce the material only in connection with reproduction of the granted patent and for no other purpose. Furthermore, the drawings may contain text or captions that may explain certain embodiments of the present disclosure. This text is included for illustrative, non-limiting, explanatory purposes of certain embodiments detailed in the present disclosure.

FIG. 1 is an image showing pure triangular gold crystals produced from a solution using PIMIRS in accordance with an embodiment of the present platform;

FIG. 2 are images showing various crystals of rare-earth compounds precipitated using PIMIRS in accordance with an embodiment of the present platform;

FIG. 3A is an image showing crystal of terbium compound and associated X-ray trace precipitated using PIMIRS in accordance with an embodiment of the present platform;

FIG. 3B is a larger image showing crystal of terbium compound of FIG. 3A in accordance with an embodiment of the present platform; and

FIG. 3C is a graph showing X-ray trace of crystal of terbium compound of FIG. 3A in accordance with an embodiment of the present platform.

### DETAILED DESCRIPTION OF THE INVENTION

The present invention can be understood more readily by reference to the following detailed description of the invention and the Examples included therein.

Before the present compositions, materials, articles, systems, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar to or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification. All publications mentioned herein are incorporated herein by reference to disclose and describe the methods and/or materials in connection with which the publications are cited.

### A. DEFINITIONS

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a leg” includes two or more legs.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units is also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

A weight percent (wt. %) of a component, unless specifically stated to the contrary, is based on the total weight of the formulation or composition in which the component is included.

As briefly described above, the present disclosure provides plant extracts and materials capable of selectively precipitating metal from aqueous solutions. In one aspect, such plant extracts and materials can be utilized to recover various rare earth elements (REEs) from aqueous solutions, for example, precipitated as pure metal or metallic-compound crystals (such as oxides or hydroxides). The present disclosure also provides methods for the preparation and use of such plant extracts and materials. In further aspects, such plant extracts and materials according to the present disclosure may be referred to herein as “Plant Induced Metal Ion Reductants” or “PIMIRS,” and refer to plant extracts and materials that when added to aqueous solutions containing various metal ions and adjusted to specific conditions, are effective to cause the transformation of metal ions in solution into structured crystal lattices. Without wishing to be bound by a particular theory, it is believed that formation of the crystals may occur through a reduction process, whereby the PIMIRS provide a rapid and specific channeling of electrons to reducing sites. In further aspects, under effective conditions, the metal ions that are subsequently precipitated cluster with other metals or compounds of the same type, forming high-purity crystals. In still further aspects, where multiple metal species are present, the individual crystals formed using PIMIRS may contain only one metal.

In various aspects, conventional biomass-based metal recovery systems may operate primarily through adsorption mechanisms, in which metal ions bind to surface sites on biomass or synthetic resins through electrostatic attraction, ion exchange, or complexation, with the metal remaining in ionic form on the adsorbent surface. Such adsorption systems may require subsequent chemical elution to release the adsorbed metal ions back into solution for further processing, followed by separate precipitation or electrowinning steps to obtain the metal in solid form. In some embodiments, the PIMIRS-mediated process may differ fundamentally from such adsorption-based systems by facilitating electron transfer from the algae-derived surface layers to the metal ions, reducing the ions to lower oxidation states or to elemental metal. The reduced metal atoms or metal-oxide species may then nucleate and grow into discrete crystalline structures on the PIMIRS surface. This reduction and crystallization mechanism may provide several advantages over adsorption-only systems. The formation of neutral or low-charge crystal structures may weaken the interaction with the PIMIRS surface compared to ionic adsorption, enabling natural desorption at critical size. The crystalline form may be directly suitable for downstream metallurgical processing without requiring re-dissolution and re-precipitation steps. The reduction process may be selective for certain metals based on their reduction potentials and the pH-dependent availability of electrons from the PIMIRS, allowing recovery of target metals from complex mixtures without prior separation.

In some embodiments, the substantially single-metal crystals may comprise at least 90% of a single metal species by weight, such as at least 92%, at least 95%, at least 97%, or at least 99% of a single metal species. The high purity of the crystals may result from the selective binding affinity of the PIMIRS surface layers for specific metal ions and the controlled reduction or precipitation conditions. In some aspects, the purity may be determined by analytical techniques such as X-ray fluorescence (XRF) spectroscopy, inductively coupled plasma mass spectrometry (ICP-MS), or energy-dispersive X-ray spectroscopy (EDS). The substantially single-metal nature of the crystals may minimize the need for subsequent refining steps and may provide crystals suitable for direct use in metallurgical applications. In some embodiments, minor impurities may include other metal species present in the source solution at concentrations below about 10% by weight, or non-metallic elements such as oxygen, hydrogen, or carbon that may be incorporated into metal-oxide or metal-hydroxide crystal structures.

In further aspects, conventional selective precipitation or co-precipitation methods applied to multi-metal solutions may result in mixed-metal precipitates, co-precipitates, or solid solutions in which two or more metals are incorporated into the same crystal lattice or aggregate. When pH is adjusted or precipitating reagents are added to a solution containing multiple metal species, metals with similar chemical properties may precipitate simultaneously and form mixed-phase solids. Separation of individual metals from such mixed precipitates may require additional dissolution, selective leaching, or other refining steps. In some embodiments, the formation of substantially single-metal crystals from multi-metal solutions may distinguish the PIMIRS process from such conventional precipitation systems. The PIMIRS composition may promote the formation of discrete, substantially single-metal crystals even when multiple metal species are present in solution at comparable concentrations. This selectivity may arise from the site-specific reduction mechanism, in which a first metal ion binds and is reduced at a surface site, and subsequent metal atoms of the same species preferentially add to the growing crystal nucleus due to lattice matching and local chemical environment. Metals with different reduction potentials, ionic radii, or crystal structures may nucleate at separate sites and grow as separate crystals. The result may be a population of crystals in which each individual crystal is predominantly composed of a single metal species, facilitating physical separation by size, density, magnetic properties, or other characteristics without requiring chemical separation of the metals prior to precipitation.

In some embodiments, the PIMIRS composition may be used to recover noble metals from aqueous solutions containing noble metal ions. Gold may be recovered from solutions containing Au(III) or Au(I) ions, with reduction to metallic gold crystals occurring at pH values between about 2 and about 8. Silver may be recovered from Ag(I) solutions, with metallic silver crystal formation favored at pH values between about 4 and about 10. Platinum group metals may also be recovered using PIMIRS. Platinum may be recovered from Pt(II) or Pt(IV) solutions at pH values between about 3 and about 9, with reduction to metallic platinum or platinum oxide crystals. Palladium may be recovered from Pd(II) solutions at pH values between about 4 and about 10, forming metallic palladium crystals. Rhodium may be recovered from Rh(III) solutions at pH values between about 3 and about 8. Iridium may be recovered from Ir(III) or Ir(IV) solutions at pH values between about 3 and about 9. Ruthenium may be recovered from Ru(III) or Ru(IV) solutions at pH values between about 2 and about 8. Osmium may be recovered from Os(IV) or Os(VIII) solutions at pH values between about 2 and about 7. The recovery efficiency for noble metals may typically exceed 90% within contact times of about 1 hour to about 12 hours, depending on the initial metal ion concentration and pH conditions.

In some embodiments, the PIMIRS composition may be used to recover transition metals from aqueous solutions. Copper may be recovered from Cu(II) solutions at pH values between about 5 and about 10, forming copper hydroxide or metallic copper crystals. Nickel may be recovered from Ni(II) solutions at pH values between about 6 and about 10, with formation of nickel hydroxide crystals. Cobalt may be recovered from Co(II) solutions at pH values between about 6 and about 10, forming cobalt hydroxide or cobalt oxide crystals. Iron may be recovered from Fe(II) or Fe(III) solutions at pH values between about 4 and about 9, with formation of iron hydroxide or iron oxide crystals. Manganese may be recovered from Mn(II) solutions at pH values between about 6 and about 10, forming manganese hydroxide or manganese oxide crystals. Zinc may be recovered from Zn(II) solutions at pH values between about 6 and about 10, with formation of zinc hydroxide crystals. Chromium may be recovered from Cr(III) or Cr(VI) solutions at pH values between about 5 and about 9, forming chromium hydroxide or chromium oxide crystals. Vanadium may be recovered from V(III), V(IV), or V(V) solutions at pH values between about 4 and about 9. Titanium may be recovered from Ti(IV) solutions at pH values between about 3 and about 8, forming titanium oxide or titanium hydroxide crystals. Scandium may be recovered from Sc(III) solutions at pH values between about 5 and about 9. Yttrium may be recovered from Y(III) solutions at pH values between about 6 and about 9, forming yttrium hydroxide crystals. The recovery efficiency for transition metals may range from about 70% to about 95% within contact times of about 2 hours to about 24 hours.

In some embodiments, the form of the substantially single-metal crystals may be controlled by adjusting solution conditions such as pH, oxidation-reduction potential, and the presence of reducing or oxidizing agents. Metallic crystals may form under reducing conditions, particularly for noble metals such as gold, silver, platinum, and palladium, where the PIMIRS composition provides electrons that reduce metal ions to their zero-valent metallic state. For example, gold ions may be reduced to metallic gold crystals at pH values between about 2 and about 8 in the presence of PIMIRS. Metal-oxide crystals may form under oxidizing or neutral conditions, particularly for metals with stable oxide forms such as iron, manganese, titanium, and cerium. For example, iron may form iron oxide (Fe₂O₃ or Fe₃O₄) crystals at pH values between about 5 and about 9. Metal-hydroxide crystals may form under alkaline conditions where hydroxide ions are abundant, particularly for metals such as copper, nickel, zinc, and rare earth elements. For example, copper may form copper hydroxide (Cu(OH)₂) crystals at pH values between about 7 and about 10. The selection of crystal form may be tailored to the intended downstream processing or application, with metallic forms preferred for direct metallurgical use and oxide or hydroxide forms preferred for applications requiring specific chemical reactivity or stability.

In some aspects, without wishing to be bound by theory, it is believed that initially neutral, non-selective reducing sites may be present on the surface layers or cell fragments that form the PIMIRS. A first metal ion present in solution may bind at one of these sites and may become reduced under suitable pH conditions, with associated proton release into the surrounding medium. The local proton release may lower the pH in the vicinity of the site and may cause conformational changes that maintain the site in a reduced, metal-selective state. In further aspects, neutral metal atoms associated with the site may be held in close proximity by van der Waals forces or Casimir-type forces, and additional atoms of the same metal may be added stepwise to form a single-metal or metal-oxide crystal lattice. Over time, the crystal may grow to a critical size at which the interaction between the crystal and the PIMIRS surface weakens, and the crystal may detach or desorb from the PIMIRS into the surrounding medium.

In some embodiments, the critical size at which natural desorption may occur can be in a range from about 10 microns to about 50 microns, such as from about 20 microns to about 40 microns. In further aspects, the critical size may depend on the specific metal species, the pH of the solution, and the concentration of metal ions. For example, rare-earth element crystals may naturally desorb when they reach an average dimension of about 25 microns to about 35 microns. In other embodiments, transition metal crystals may desorb at sizes ranging from about 15 microns to about 30 microns. The critical size may be determined empirically by monitoring crystal growth over time and observing the point at which crystals separate from the PIMIRS surface without mechanical agitation or chemical treatment.

In further aspects, conventional metal recovery systems using biomass-based adsorbents may rely on a two-stage process in which metal ions are first adsorbed onto the biomass surface, and then subsequently released through chemical desorption treatments. Such systems may require treatment with strong acids, acidic thiourea solutions, ammonia-ammonium salt mixtures, alkaline solutions, or metal chelate solutions to release adsorbed metals from the biomass. These chemical desorption steps may add process complexity, increase chemical consumption, generate additional waste streams, and potentially contaminate the recovered metal product with desorption reagent residues. In some embodiments, the natural desorption process enabled by the PIMIRS composition may eliminate the need for such chemical desorption treatments. The natural desorption mechanism may allow crystals to separate spontaneously from the algae-derived surface once gravitational forces exceed adhesion forces at the critical size. This spontaneous release may occur without addition of thiourea, without ammonia-ammonium salt solutions, without strong acid elution, and without alkaline or chelating desorption reagents. The elimination of chemical desorption may reduce process costs, simplify equipment requirements, minimize worker exposure to hazardous chemicals, and yield recovered metal crystals of higher purity.

The compounds described in the invention can be present as a solvate. In some cases, the solvent used to prepare the solvate is an aqueous solution, and the solvate is then often referred to as a hydrate. The compounds can be present as a hydrate, which can be obtained, for example, by crystallization from a solvent or from aqueous solution. In this connection, one, two, three or any arbitrary number of solvate or water molecules can combine with the compounds according to the invention to form solvates and hydrates. Unless stated to the contrary, the invention includes all such possible solvates.

The term “co-crystal” means a physical association of two or more molecules which owe their stability through non-covalent interaction. One or more components of this molecular complex provide a stable framework in the crystalline lattice. In certain instances, the guest molecules are incorporated in the crystalline lattice as anhydrates or solvates, see e.g., Almarasson, O., et. al. (2004) The Royal Society of Chemistry, 1889-1896. Examples of co-crystals include p-toluenesulfonic acid and benzenesulfonic acid.

It is known that chemical substances form solids which are present in different states of order which are termed polymorphic forms or modifications. The different modifications of a polymorphic substance can differ greatly in their physical properties. The compounds according to the invention can be present in different polymorphic forms, with it being possible for particular modifications to be metastable. Unless stated to the contrary, the invention includes all such possible polymorphic forms.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Disclosed are the materials, components, parts, and/or elements to be used to manufacture the disclosed compositions, methods and systems of the invention as well as the materials themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions and systems of the invention. Thus, if there are a variety of additional steps that can be performed it is understood that each of these additional steps can be performed with any specific aspect or combination of aspects of the methods of the invention.

It is understood that the compositions and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. COMPOSITIONS, FORMULATIONS, AND AGENTS

As briefly described above, the present disclosure provides, in various aspects, compositions, formulations, materials, agents, biologically derived reductants for the recovery of metal. Biologically derived reductants, such as Plant Induced Metal Ion Reductants (PIMIRS), may offer several advantages over traditional chemical reagents. These reductants may be derived from algae, which are known for their natural affinity to bind with metal ions. The use of algae-based reductants may minimize the reliance on harsh chemical processes, potentially reducing environmental harm. PIMIRS may also be tailored to enhance the specificity of metal ion recovery, which could lead to a more efficient separation process. This specificity may allow for the recovery of metals in forms that are directly usable in various industrial applications, potentially eliminating the need for further processing.

The design of these biologically derived reductants may include features that facilitate easier integration into existing metal recovery systems. For instance, PIMIRS may be formulated to operate effectively across a broad range of pH values, accommodating different industrial environments without requiring extensive modifications to existing equipment. Additionally, the potential for these reductants to be regenerated and reused may offer a cost-effective solution, contributing to a more sustainable metal recovery process. The ability of PIMIRS to selectively bind with specific metal ions may reduce the occurrence of non-target metal recovery, thereby enhancing the purity of the recovered metals.

Furthermore, the implementation of PIMIRS may lead to a reduction in energy consumption. This is because the process may operate at ambient temperatures and ambient pressures, unlike some traditional methods that require elevated temperatures. The reduction in energy use not only lowers operational costs but also aligns with environmental sustainability goals. The biodegradable nature of PIMIRS may further ensure that after their useful life, they break down into non-toxic components, minimizing environmental impact. This feature contrasts with many conventional reductants that may pose disposal challenges and environmental hazards.

In some embodiments, the metal reduction processes that use PIMIRS may be carried out over a range of temperatures and pressures. For example, the systems may operate effectively at temperatures from about 0° C. to about 80° C., such as from about 15° C. to about 45° C., and at pressures from about 0.8 atmospheres to about 2 atmospheres. In further aspects, the ability to perform metal reduction at or near ambient temperature and pressure, without the need for high-temperature, high-pressure reactors, may facilitate integration into existing treatment infrastructure and may allow deployment at remote or distributed sites.

In summary, the innovative use of biologically derived reductants like PIMIRS in metal recovery processes may address several limitations of traditional methods by enhancing metal recovery efficiency, reducing environmental impact, and lowering operational costs. These advantages may position PIMIRS as a valuable alternative in the field of material science and chemistry, particularly in applications requiring the recovery and reduction of metal ions. The intuitive design elements of PIMIRS include the specific selection and processing of algae species known for their metal ion reduction capabilities. This tailored approach may allow for a higher specificity and efficiency in the binding and reduction of metal ions compared to traditional methods. The use of algae from the order Cyanidiales, for example, from the genus Galdieria, such as the species Galdieria sulphuraria, which can be optimized for metal ion interaction, may enhance the selectivity of PIMIRS towards specific metal ions. This targeted functionality may be critical in applications where the precise recovery of particular metals is required.

In further aspects, the compositions and formulations may include specific types of algae, such as those belonging to the order Cyanidiales, which may exhibit a high affinity for binding with various metal ions. In some aspects, the genus may be Galdieria. In other aspects, the species may be Galdieria sulphuraria. The compositions may be tailored to selectively recover various types of metals, including noble metals, transition metals, and rare-earth elements (REEs). Furthermore, the crystals formed during the recovery process may contain only one metal species, enhancing the purity of the recovered metals. In some embodiments, specific chelating agents and/or pH adjusters that optimize the environment for metal recovery may optionally be included. In other embodiments, the addition of antioxidants within the formulations may help in preserving the integrity and functionality of the active components during storage and use.

In some embodiments, the PIMIRS composition may be particularly effective for recovering REEs from aqueous solutions. Representative REE species that may be recovered include lanthanum, cerium, praseodymium, neodymium, promethium, samarium, europium, gadolinium, terbium, dysprosium, holmium, erbium, thulium, ytterbium, lutetium, scandium, and yttrium. The recovery of REEs may be enhanced by adjusting the pH to a range where REE ions form hydroxide or oxide precipitates on the PIMIRS surface. For example, neodymium ions may be effectively recovered at pH values between about 7 and about 9, where neodymium hydroxide crystals form on the algae-derived surface layers. In another example, cerium may be recovered at pH values between about 6 and about 8, with formation of cerium oxide or cerium hydroxide crystals. The selectivity for REEs over other metal ions may be achieved by controlling pH, contact time, and the ratio of PIMIRS to metal ion concentration. In some embodiments, REE recovery efficiency may exceed 85% within a contact time of about 2 hours to about 24 hours.

In further aspects, the selective recovery capabilities of the compositions may be directed towards noble metals, transition metals, and (REEs, with each crystal produced potentially containing only one metal species. In specific embodiments, the formulations may be configured for efficient recovery of metals from industrial waste streams or for the selective extraction of heavy metals from contaminated soil and water. These formulations may include soil and water conditioners to facilitate the mobilization of heavy metals towards the bioactive sites for enhanced recovery efficiency.

In some aspects, the metals that may be recovered using PIMIRS can include a wide range of elements from the periodic table in addition to noble metals, transition metals, and REEs. Representative examples may include arsenic, selenium, mercury, lead, cadmium, uranium, thorium, cesium, and strontium, including radioactive isotopes such as cesium-137 and strontium-90. In various embodiments, solutions that contain many different metal ions simultaneously may be contacted with PIMIRS, and the resulting crystals may each comprise essentially a single metal species or a corresponding oxide or hydroxide, even when multiple metal ions are present in the solution at comparable concentrations. In further aspects, this behavior may occur over a wide range of input metal ion concentrations and may allow selective physical separation of single-metal crystals from mixed-metal solutions without prior chemical separation of the ions.

Overall, the detailed description of the compositions and formulations herein may provide a comprehensive understanding of the various components and their interactions within the algae-based metal recovery systems. These systems may offer an environmentally friendly alternative to conventional metal recovery methods, utilizing the natural properties of algae to facilitate efficient and selective metal recovery without the reliance on harsh chemicals or extensive processing steps. The compositions and methods described herein may involve the use of algae-based materials for the recovery of metals from various solutions. These materials may be derived from both living and dead algae cells, or from fragments of these cells, including the surface layers. The metals may be recovered in the form of crystals such as pure, single-metal crystals, metal-oxide crystals, or metal-hydroxide crystals. These crystals are initially absorbed onto the algae-based materials and may be naturally desorbed without the need for a desorption reagent once they reach a certain size.

In some aspects, the platform provides a composition for selective metal recovery including a material derived from the living or dead cells or cell fragments of an alga, or the surface layer of living or dead cells of an alga; wherein the metal is recovered in the form of pure, single-metal crystals, or metal-oxide crystals, or metal-hydroxide crystals, which are initially adsorbed to the said living or dead cells or cell fragments or surface layer of living or dead cells, and which are eventually naturally desorbed from said living or dead cells or cell fragments, or surface layer of living or dead cells, without the use of a desorption reagent, once the said crystals reach some critical size.

In other aspects, the platform provides a formulation of PIMIRS for the selective recovery of metals, including a base composition derived from algae known for high affinity to REEs.

In some aspects, the platform provides a composition for the selective recovery of metals, including: algae extracts specifically processed to maximize the surface area and adsorption sites for precious metals; additives that stabilize the PIMIRS in solutions with high metal ion concentrations; buffering agents to maintain the solution at an optimal pH for precious metal recovery.

In some aspects, the platform provides a formulation of PIMIRS configured for the efficient recovery of transition metals from industrial waste streams, including: a base extract from a selected species of algae known for its high affinity to transition metals.

In some aspects, the platform provides a formulation for the selective extraction of heavy metals from contaminated soil and water, including: algae-derived bioactive compounds tailored to bind specifically with heavy metals; soil and water conditioners that facilitate the mobilization of heavy metals towards the bioactive sites of PIMIRS.

In some aspects, the platform provides a formulation designed for multi-metal recovery, capable of selectively recovering different metals from a mixed metal solution, including: a base composition that includes a blend of plant extracts each having a selective affinity for different metal ions; modifiers that adjust the reactivity of the PIMIRS based on the ionic composition of the solution.

In some aspects, the platform provides a formulation characterized by its rapid metal ion reduction capability, including: a blend of plant extracts optimized for quick electron transfer to metal ions in solution.

In some aspects, the platform provides a formulation designed for selective adsorption and collection of specific types of metal ores, including: a base composition of plant extracts tailored to target specific metal ions.

In some aspects, the platform provides a formulation characterized by enhanced electron transfer capabilities for rapid metal ion reduction, including: a blend of plant extracts from Galdieria sulphuraria optimized for high electron donor-electron acceptor capacity.

In some aspects, the platform provides the formulation or composition of any preceding claim, wherein the formulation or composition selectively recovers one or more noble metals and/or one or more transition metals and/or one or more REEs.

In further aspects, the alga may belong to the order Cyanidiales. The composition may selectively recover one or more noble metals and/or one or more transition metals and/or one or more REEs. Each crystal produced may contain only one metal species. In still further aspects, the Algae extracts may be specifically processed to maximize the surface area and adsorption sites for precious metals; and may include additives that stabilize the PIMIRS in solutions with high metal ion concentrations; and/or buffering agents to maintain the solution at an optimal pH for precious metal recovery.

In still further aspects, the formulation may be tailored for use in high-temperature environments, ensuring that after metal recovery, the PIMIRS break down into non-toxic components, minimizing environmental impact. The pH modifiers may be capable of rapid adjustment to react to fluctuating pH levels in industrial waste streams, maintaining effective metal recovery conditions. While not needed at very low pH, microbial inhibitors may be added that prevent the growth of unwanted bacteria and fungi during the application of PIMIRS in environmental cleanup projects.

In some aspects, a formulation designed for multi-metal recovery, capable of selectively recovering different metals from a mixed metal solution, may include a base composition that includes a blend of plant extracts each having a selective affinity for different metal ions; modifiers that adjust the reactivity of the PIMIRS based on the ionic composition of the solution. Modifiers include pH adjusters that enable the PIMIRS to function optimally in a range of industrial environments with varying acidity or alkalinity. A binding enhancer that increases the physical stability of the PIMIRS-metal complex may be included, facilitating easier separation and purification of recovered metals.

In some aspects, formulations may be configured to selectively recover precious metals such as gold and silver from electronic waste, including specific ligands that bind strongly to these metals. In other aspects, the formulation may be characterized by its rapid metal ion reduction capability, including: a blend of plant extracts optimized for quick electron transfer to metal ions in solution. The plant extracts are preferably derived from algae species known for their high electron donor-electron acceptor properties.

In some aspects, a formulation may be designed for selective adsorption and collection of specific types of metal ores, including: a base composition of plant extracts tailored to target specific metal ions. pH adjusters that optimize the ionic charge environment for selective adsorption of metal ores may be added.

In various aspects, the formulations may be designed to function effectively in a wide range of solvent systems, including aqueous and non-aqueous environments, to accommodate different industrial applications.

In some aspects, the formulations may be characterized by enhanced electron transfer capabilities for rapid metal ion reduction, including: a blend of plant extracts from Galdieria sulphuraria optimized for high electron donor-electron acceptor capacity; and an electron mediator that facilitates the transfer of electrons from the PIMIRS to the metal ions in solution. The electron mediator may be a naturally occurring organic compound that forms a complex with metal ions, reducing the activation energy required for electron transfer. pH adjusters that optimize the ionic environment to enhance the electron transfer rate from PIMIRS to metal ions may be included.

In some aspects, a conductivity enhancer may be added that increases the ionic conductivity of the solution, thereby facilitating more efficient electron transfer between PIMIRS and metal ions. The enhancer could be an ionic salt or a conductive polymer that does not react with the metal ions but improves the overall electron flow in the solution, leading to faster and more complete reduction of metal ions. A redox-active co-factor that temporarily stores electrons and sequentially transfers them to metal ions may be added, thereby stabilizing the electron transfer process and reducing the occurrence of incomplete metal ion reduction. The co-factor could be a redox-active organic compound or a metalloenzyme that acts as an intermediary electron carrier, smoothing the electron flow from PIMIRS to the metal ions and enhancing the control over the reduction process. A buffering agent may be added to maintain the pH within an optimal range for electron transfer during the metal recovery process. An antioxidant agent that prevents oxidative degradation of electron-donating groups within PIMIRS may be added. The electron mediator may be a synthetic quinone compound known for its ability to shuttle electrons efficiently between biological materials and metal ions. A metal ion chelator that temporarily binds metal ions may include, bringing them into closer proximity to PIMIRS and enhancing the rate of electron transfer. A surfactant that improves the dispersibility of PIMIRS in aqueous solutions may be included, increasing the contact surface area with metal ions. Additional modifiers may include a catalyst that facilitates the reduction of metal ions at lower energy states than typically required. Ionic liquids as part of the composition may be added to enhance the solubility of metal ions, facilitating more efficient electron transfer from PIMIRS. The electron mediator may be coupled with a fluorescent marker that allows for real-time monitoring of the electron transfer process during metal recovery. A pH-sensitive polymer may be added that adjusts the release of electron mediators based on the acidity of the solution, optimizing the timing of electron transfer.

Furthermore, the design of PIMIRS may include the integration of biodegradable and environmentally friendly components. This aspect of the design not only supports the sustainability of the process but also reduces the ecological footprint associated with metal recovery operations. The biodegradability of PIMIRS may ensure that after their effective life, they break down into non-toxic byproducts, which is beneficial for maintaining environmental integrity, and can optionally be used in weak and degraded soils as a mechanism for soil rejuvenation.

In some aspects, PIMIRS or PIMIRS that contain adsorbed metal or metal-oxide crystals may be subjected to freeze-drying or lyophilization. In certain embodiments, freezing and subsequent sublimation of water from a PIMIRS slurry may cause the metal or metal-oxide crystals to separate spontaneously from the dried PIMIRS matrix, thereby facilitating their physical collection by gentle agitation, sieving, or fluidization. In further aspects, PIMIRS may be freeze-dried in the absence of metal ions to form a powder that may be reconstituted in aqueous solution at a later time, while retaining substantial metal-reduction activity after rehydration.

These intuitive design elements collectively contribute to making the PIMIRS platform a technically advanced solution for metal recovery, distinguishing it from prior art by offering enhancements in specificity, adaptability, and environmental sustainability. The design of PIMIRS may incorporate a variety of elements that enhance its functionality in metal recovery processes. One such element may be the use of modular components that allow for easy adaptation to different industrial environments. This modularity may facilitate the integration of PIMIRS into existing systems without the need for extensive modifications. Additionally, the inclusion of real-time monitoring systems may enable dynamic adjustments to the PIMIRS dosage and pH levels, optimizing the metal recovery process based on immediate feedback from the operational environment.

Another design aspect of PIMIRS may involve the use of advanced sensor technology. These sensors may detect variations in metal ion concentrations and enable the system to automatically adjust the flow and treatment parameters. This capability may ensure that the PIMIRS operate at optimal efficiency, regardless of fluctuations in the input stream.

Overall, the combination of modularity, real-time adjustments, and environmentally conscious design elements may position PIMIRS as a superior choice for industries seeking efficient and sustainable metal recovery solutions.

### C. METHOD AND SYSTEM CONFIGURATION

As briefly described above, the present disclosure provides, in further aspects, various methods and systems for the recovery of metal using biological derived materials and agents. According to various embodiments of the platform, methods and systems of the present disclosure can comprise multiple configurations. These methods and systems may involve the use of Plant Induced Metal Ion Reductants (PIMIRS) which may be derived from specific algae species known for their metal ion reduction capabilities. The PIMIRS may be introduced into a solution containing metal ions, where they may bind to the metal ions and facilitate their reduction to pure, single-metal crystals, or metal-oxide crystals, or metal-hydroxide crystals. The methods may include steps of adjusting the pH of the solution to optimize the reduction environment for the PIMIRS and the metal ions. This pH adjustment may be critical for maintaining the efficiency and effectiveness of the metal reduction process. Additionally, the methods may involve maintaining the solution under conditions that promote the interaction between the metal ions and the PIMIRS, thereby enhancing the reduction process.

In some embodiments, the contacting step may be performed by adding the PIMIRS composition to the aqueous solution containing metal ions. The PIMIRS composition may be added as a dry powder, a slurry, or a suspension, and may be dispersed throughout the solution by stirring, agitation, or mixing. The ratio of PIMIRS to solution may range from about 0.1 g/L to about 50 g/L, such as from about 1 g/L to about 20 g/L. In other embodiments, the contacting step may be performed by adding the aqueous solution to a pre-measured quantity of PIMIRS composition in a reaction vessel. This approach may be suitable for batch processing where the PIMIRS composition is prepared in advance and the metal-containing solution is introduced incrementally. In further embodiments, the contacting step may be performed by flowing the aqueous solution through a bed or column containing the PIMIRS composition. The PIMIRS composition may be packed into a column with dimensions suitable for the solution volume and flow rate, such as columns with diameters ranging from about 1 cm to about 100 cm and heights ranging from about 10 cm to about 200 cm. The flow rate may range from about 0.1 bed volumes per hour to about 10 bed volumes per hour, such as from about 0.5 bed volumes per hour to about 5 bed volumes per hour. The column configuration may allow for continuous or semi-continuous operation, with fresh solution introduced at one end and metal-depleted solution exiting at the other end.

In some embodiments, the desorbed crystals may be separated from the aqueous solution by physical separation techniques that exploit differences in size, density, or settling characteristics between the crystals and the solution. Suitable separation methods may include gravitational settling, where the crystals are allowed to settle to the bottom of a vessel over a period of about 10 minutes to about 24 hours, depending on crystal size and density. In other embodiments, centrifugation may be used to accelerate separation, with centrifugal forces ranging from about 100 g to about 10,000 g applied for about 1 minute to about 30 minutes. Filtration may also be employed, using filter media with pore sizes selected to retain the crystals while allowing the solution to pass through, such as filters with pore sizes ranging from about 0.1 microns to about 50 microns. In further embodiments, magnetic separation may be used for crystals containing ferromagnetic or paramagnetic metals such as iron, nickel, or cobalt. The separated crystals may be washed with deionized water or a dilute acid or base solution to remove residual solution components, then dried at temperatures ranging from about 25° C. to about 150° C. for about 1 hour to about 24 hours to obtain the final recovered metal product.

The systems for implementing these methods may comprise a reaction vessel configured to contain the metal ion solution and the PIMIRS. This vessel may be equipped with a pH control system designed to monitor and adjust the pH of the solution continuously. The systems may also include a separation unit that isolates the pure, single-metal crystals, or metal-oxide crystals, or metal-hydroxide crystals from the solution after the reduction process is complete.

The purpose of these methods and systems may be to recover metals from solutions in a selective and efficient manner. The key functions of the invention may include the selective binding of PIMIRS to metal ions, the reduction of metal ions to pure, single-metal crystals, or metal-oxide crystals, or metal-hydroxide crystals, and the separation of these crystals from the solution. These functions may collectively contribute to the efficient recovery of metals, which may be useful in various industrial applications, including the manufacture of electronic components and the purification of water.

In summary, the disclosed methods and systems may provide a biologically inspired approach to metal recovery, utilizing the natural properties of specific algae to reduce oxidize metal ions in solutions to form pure, single-metal crystals, or metal-oxide crystals, or metal-hydroxide crystals. These methods and systems may offer advantages in terms of selectivity, efficiency, and environmental sustainability.

The disclosed methods and systems may utilize algae to facilitate the reduction of metal ions in solutions, resulting in the formation of pure, single-metal crystals, or metal-oxide crystals, or metal-hydroxide crystals. This process may leverage the innate biochemical pathways of algae, which may be capable of binding and reducing metal ions effectively. By harnessing these natural properties, the systems and methods may achieve metal recovery with enhanced selectivity and minimal environmental impact.

The use of specific algae, such as those from the order Cyanidiales, may be particularly effective in these processes due to their robustness and efficiency in metal ion binding and reduction. These algae may be utilized in either living or dead forms, or even as isolated cell fragments, which may still retain metal-binding and reducing capabilities.

In the context of these systems and methods, the pure, single-metal crystals, or metal-oxide crystals, or metal-hydroxide crystals formed may initially be adsorbed onto the surface of the algae or its components. Over time, these crystals may grow in size and eventually may be naturally desorbed from the algae's surface without the need for external desorption agents. This natural desorption process may occur once the crystals reach a critical size, which facilitates their recovery and minimizes the use of additional chemicals.

In some embodiments, the aqueous solution may be agitated during the contacting step to enhance mass transfer of metal ions to the PIMIRS surface and to maintain the PIMIRS composition in suspension. Agitation may be provided by mechanical stirring using impellers, magnetic stir bars, or overhead stirrers operating at rotational speeds ranging from about 50 rpm to about 500 rpm, such as from about 100 rpm to about 300 rpm. In other embodiments, agitation may be provided by shaking, such as orbital shaking at frequencies ranging from about 50 oscillations per minute to about 300 oscillations per minute. Gas sparging, such as bubbling air or an inert gas through the solution, may also provide agitation while maintaining aerobic or anaerobic conditions as desired. The intensity of agitation may be selected to provide adequate mixing without causing mechanical damage to the PIMIRS composition or preventing crystal formation and desorption. In some embodiments, gentle agitation may be preferred during the initial adsorption phase, with reduced or intermittent agitation during the crystal growth and desorption phases to allow crystals to settle and separate. In continuous flow systems, agitation may be provided by the flow itself, with turbulent flow conditions promoting contact between metal ions and PIMIRS surfaces.

In some embodiments, the pH of the aqueous solution may be adjusted before the contacting step by adding a pH-adjusting agent to the solution and mixing until the desired pH is achieved. The pH may be monitored using a pH meter, pH indicator strips, or colorimetric indicators. The amount of pH-adjusting agent required may be determined by titration or by incremental addition with continuous pH monitoring. For example, to adjust a solution from pH 3 to pH 8, sodium hydroxide solution may be added dropwise while stirring until the pH meter indicates the target pH has been reached. In other embodiments, the pH may be adjusted during the contacting step by adding the pH-adjusting agent after the PIMIRS composition has been introduced to the solution. This approach may be useful when the initial adsorption is desired at one pH and subsequent crystal formation is favored at a different pH. For instance, metal ions may be allowed to adsorb at an acidic pH, followed by pH adjustment to an alkaline range to promote hydroxide crystal formation. The pH-adjusting agents may be added as concentrated solutions, such as 1 M to 10 M sodium hydroxide or potassium hydroxide, or as solid powders such as sodium carbonate or sodium bicarbonate. The selection of pH-adjusting agent and the timing of pH adjustment may be optimized based on the target metal species and the desired crystal form. In some embodiments, pH may be adjusted to a range of about 2 to about 12 for broad-spectrum metal recovery, to a range of about 4 to about 10 for most transition metals and noble metals, or to a range of about 6 to about 9 for optimal rare earth element (REE) recovery.

Furthermore, the systems and methods may be designed to selectively recover various types of metals, including noble metals, transition metals, and REEs. This selectivity may be enhanced by the inclusion of specific chelating agents and pH adjusters in the formulation, which may optimize the metal recovery environment and improve the efficiency of the process.

In various aspects, the disclosed methods and systems may be effective for recovering metals from aqueous solutions with initial metal ion concentrations ranging from about 0.1 ppm to about 10,000 ppm. At lower concentrations, such as from about 0.1 ppm to about 10 ppm, the method may be particularly useful for treating dilute wastewaters or environmental remediation applications where trace metal removal is required. At these concentrations, longer contact times or higher PIMIRS-to-solution ratios may be employed to achieve adequate recovery efficiency. At intermediate concentrations, such as from about 1 ppm to about 5,000 ppm, the method may provide optimal balance between recovery efficiency and processing economics, with typical PIMIRS dosages of about 1 g/L to about 20 g/L and contact times of about 2 hours to about 24 hours. At higher concentrations, such as from about 10 ppm to about 1,000 ppm, the method may achieve recovery efficiencies exceeding 85% with moderate PIMIRS dosages and contact times. For very high concentrations approaching 10,000 ppm, multiple treatment cycles or increased PIMIRS dosages may be used to prevent saturation of the adsorption sites. The metal ion concentration may be measured before and after treatment using analytical techniques such as atomic absorption spectroscopy, ICP-MS, or ICP-OES to determine recovery efficiency. In some embodiments, the PIMIRS dosage may be adjusted proportionally to the initial metal ion concentration, with ratios ranging from about 0.01 grams PIMIRS per milligram of metal ion to about 10 grams PIMIRS per milligram of metal ion.

In further aspects, conventional metal recovery systems may be optimized for operation within a narrow concentration range, with reduced efficiency or altered selectivity at very low or very high metal concentrations. For example, ion-exchange resins may exhibit reduced capacity or slower kinetics at low metal concentrations due to unfavorable equilibrium, while precipitation methods may require concentration adjustment to achieve adequate supersaturation. Systems designed for high-concentration feeds, such as those treating acidic leachates from electronic waste, may be ineffective or require significant modification when applied to dilute wastewaters or trace-level contamination. In some embodiments, the PIMIRS-mediated reduction and crystal formation process may operate effectively over an exceptionally broad range of initial metal ion concentrations, from trace levels to highly concentrated solutions. The PIMIRS composition may reduce metal ions and form substantially single-metal crystals at concentrations ranging from about 1 part per billion to at least about 100,000 parts per million, or higher, while maintaining the characteristic crystal morphology and purity. This concentration independence may allow the same PIMIRS formulation and process conditions to be applied to dilute wastewaters, intermediate-concentration process streams, and highly concentrated leachates or eluates without requiring solution pre-treatment or concentration adjustment. The broad operating range may simplify process design, reduce the need for multiple treatment stages, and enable treatment of variable-composition feeds without frequent process adjustments.

In still further aspects, the aqueous solution containing metal ions may be obtained from various industrial, environmental, or waste sources. Mining wastewater may contain metals such as copper, zinc, nickel, cobalt, and REEs at concentrations ranging from about 1 ppm to about 1,000 ppm, typically with acidic pH values between about 2 and about 6. Electronic waste leachate may be obtained by leaching electronic waste materials such as printed circuit boards, computer components, or mobile phone components with an acid solution such as hydrochloric acid, nitric acid, sulfuric acid, or aqua regia, or with a base solution such as sodium hydroxide or potassium hydroxide. The leaching may be performed at temperatures ranging from about 25° C. to about 95° C. for periods of about 1 hour to about 48 hours. Electronic waste leachate may contain noble metals such as gold, silver, platinum, and palladium, as well as base metals such as copper, nickel, and tin, at concentrations ranging from about 10 ppm to about 5,000 ppm. Industrial effluent from electroplating, metal finishing, or chemical manufacturing operations may contain various transition metals at concentrations ranging from about 5 ppm to about 500 ppm. Acid mine drainage may contain iron, copper, zinc, manganese, and aluminum at concentrations ranging from about 10 ppm to about 1,000 ppm, typically with very acidic pH values between about 2 and about 4. Seawater may contain trace concentrations of various metals, typically below about 10 ppm, and may require concentration or pre-treatment before metal recovery. Groundwater and surface water contaminated by industrial activities or natural mineral deposits may contain metals at concentrations ranging from about 0.1 ppm to about 100 ppm. The method may be adapted to each solution type by adjusting pH, PIMIRS dosage, contact time, and separation methods based on the specific metal composition and concentration.

In some embodiments, the temperature during the contacting step may be maintained within a range from about 0° C. to about 100° C., depending on the metal species, solution composition, and desired recovery kinetics. Lower temperatures, such as from about 0° C. to about 25° C., may be suitable for metals that form stable crystals at ambient or reduced temperatures, and may reduce the rate of competing side reactions or degradation of the PIMIRS composition. Moderate temperatures, such as from about 10° C. to about 80° C., may provide enhanced adsorption kinetics and crystal growth rates for most metals while maintaining stability of the algae-derived surface layers. Intermediate temperatures, such as from about 15° C. to about 50° C., may be optimal for many applications, providing a balance between reaction kinetics and energy efficiency. Elevated temperatures, such as from about 50° C. to about 100° C., may accelerate crystal formation and desorption for metals with slower kinetics, but may require consideration of solution evaporation and potential thermal degradation of organic components. In some embodiments, ambient temperature operation at about 20° C. to about 30° C. may be preferred for simplicity and energy efficiency. Temperature may be controlled using water baths, heating mantles, cooling jackets, or temperature-controlled reaction vessels. The effect of temperature on recovery efficiency may be evaluated by conducting parallel experiments at different temperatures and comparing metal recovery yields.

In some embodiments, the PIMIRS composition may be reused for multiple recovery cycles by repeating the contacting, allowing, and separating steps with the same PIMIRS material. After the first cycle, the desorbed crystals may be separated from the solution, and the PIMIRS composition may remain in the solution or may be recovered by filtration or settling. The recovered PIMIRS composition may then be contacted with a fresh aqueous solution containing metal ions, or the same solution may be replenished with additional metal ions. In some aspects, the PIMIRS composition may be used for about 2 to about 20 cycles, such as about 3 to about 10 cycles, before the adsorption capacity or crystal formation efficiency decreases significantly. Between cycles, the PIMIRS composition may optionally be regenerated by washing with deionized water, dilute acid, or dilute base to remove residual metal ions or surface contaminants. For example, the PIMIRS may be washed with 0.01 M to 0.1 M hydrochloric acid or nitric acid, followed by rinsing with deionized water and pH adjustment back to the desired operating pH. In some embodiments, the recovery efficiency may remain above 80% of the initial cycle performance for at least 3 cycles, and above 60% for at least 5 cycles. The ability to reuse the PIMIRS composition may reduce material costs and improve the economic viability of the metal recovery process. The number of cycles may be limited by gradual degradation of the algae-derived surface layers, accumulation of irreversibly bound contaminants, or mechanical breakdown of the PIMIRS particles.

Additionally, the systems and methods may incorporate antioxidants to prevent oxidation of the active components, thereby preserving the functionality and efficiency of the metal recovery process during storage and use. Enzymatic treatments may also be applied to the algae to increase the availability of active sites for metal binding, further enhancing the effectiveness of the metal recovery process.

Overall, the disclosed methods and systems may provide a sustainable and efficient approach to metal recovery, utilizing the natural metal-binding and reducing capabilities of specific algae. This approach may not only offer environmental benefits but also improve the selectivity and efficiency of metal recovery processes, making it a valuable tool in various industrial applications.

According to various further aspects of the disclosure, the platform may include at least the following aspects:

In one aspect, the composition may be utilized in processes where the adsorption of metals from solutions is crucial. The alga-derived material may be integrated into systems where metal recovery is essential, such as in the recycling of electronic waste or the purification of mining runoff. The metal-binding properties of the algae may be harnessed to capture a wide range of metal ions, potentially including, but not limited to, noble metals, transition metals, and REEs. The algae may be processed in various forms to maximize its effectiveness in metal recovery applications. For instance, the algae may be treated enzymatically to break down cell walls, thereby increasing the surface area available for metal binding. Alternatively, the algae may be processed to form a powder, granules, or a liquid extract, each form being suitable for different applications depending on the specific requirements of the metal recovery process.

In various aspects, conventional metal recovery systems using algae-derived materials may require drying or thermal treatment of the harvested biomass to achieve adequate metal binding capacity, particularly when treating solutions with high acid concentrations. Such systems may employ spray-drying, freeze-drying, or vacuum drying of the harvested cells to increase acid resistance and improve handling characteristics. The dried biomass may then be contacted with acidic metal-containing solutions, where the dried cell walls and surface structures provide adsorption sites for metal ions. However, the drying step may add processing complexity, energy consumption, and capital equipment requirements. In some embodiments, the PIMIRS composition may be effective when derived from living algae cells, dead algae cells, or cell fragments, without requiring drying or thermal treatment of the biomass. The PIMIRS composition may retain metal ion reduction activity when used as fresh, undried biomass, as frozen biomass, or as a slurry or suspension of living or recently harvested cells. The ability to use undried biomass may simplify the production process, reduce energy costs, and allow deployment of the technology at sites where drying equipment is not available. In some aspects, the metal-reducing activity of the PIMIRS may be associated with enzymatic or non-enzymatic electron transfer systems that remain functional in living or freshly harvested cells, and that may be partially or fully retained even after cell death or freezing. The use of living or undried cells may also facilitate regeneration and reuse of the PIMIRS, as the cells may retain metabolic capacity to restore reducing sites between recovery cycles.

In addition to the use of raw or minimally processed algae, the composition may include various additives to enhance the metal recovery process. These additives may include pH adjusters to maintain an optimal acid-base environment for metal ion binding and reduction, chelating agents to form stable complexes with specific metal ions, and surfactants to improve the distribution of the algae-based materials in aqueous solutions.

In some embodiments, the pH-adjusting agents may be selected from strong bases, weak bases, carbonates, bicarbonates, phosphates, and buffering agents. Suitable pH-adjusting agents may include sodium hydroxide, potassium hydroxide, or ammonium hydroxide, which can provide rapid pH elevation for alkaline conditions favorable to REE precipitation. In other embodiments, carbonate-based agents such as sodium carbonate, potassium carbonate, sodium bicarbonate, or potassium bicarbonate may be used to provide buffering capacity while gradually increasing pH. Phosphate-based agents such as trisodium phosphate or tripotassium phosphate may be employed to achieve both pH adjustment and provide phosphate ions that can participate in crystal formation. In further embodiments, organic buffering agents such as sodium citrate, potassium citrate, sodium acetate, or potassium acetate may be used to maintain stable pH conditions during extended recovery operations. The selection of a particular pH-adjusting agent may depend on factors including the target metal species, the initial pH of the solution, the desired rate of pH change, and compatibility with downstream processing steps.

A key aspect of the system may be the natural desorption process, which occurs once the pure, single metal-metal, metal-oxide, or metal-hydroxides crystals reach a critical size. This feature may be particularly beneficial in reducing the need for additional chemicals or reagents to release the metals from the algae matrix, thereby simplifying the process and potentially reducing the environmental impact.

The system may be designed to operate under a variety of environmental conditions. For example, the composition may include thermal stabilizers to maintain its functionality across a wide range of temperatures, or it may include antioxidants to prevent oxidation of the active components during storage and use.

Overall, the described methods and systems may provide a versatile and environmentally friendly solution to metal recovery challenges, with potential applications in a wide range of industries where metal contamination is a concern or where metal recycling is desired. The use of algae, a renewable and biodegradable resource, in such systems may further enhance their sustainability and reduce the environmental footprint of metal recovery operations. The methods and systems discussed may be applied in various sectors, including but not limited to, mining, electronics recycling, and environmental remediation. These applications benefit from the adaptability of the described compositions and formulations to different industrial needs and regulatory standards. The integration of algae-based components offers a biologically inspired approach to metal recovery, leveraging natural processes for sustainable industry practices.

In some embodiments, PIMIRS may be used to remove toxic metals and metalloids from potable water, surface water, or groundwater. Representative target species may include arsenic, selenium, mercury, lead, and cadmium present in concentrations ranging from about 1 part per billion to at least about 2.6 g/L. In further aspects, the PIMIRS may be contacted with water adjusted to a pH in a range from about 6 to about 9, such as about pH 8, and may reduce and precipitate the target ions as pure, single-metal crystals, or metal-oxide crystals, or metal-hydroxide crystals. The PIMIRS may be separated and reused in many successive treatment cycles while maintaining substantial removal efficiency. In some embodiments, the PIMIRS may be configured and dosed such that the residual concentration of arsenic or other toxic metals in treated water may be reduced below typical drinking water standards.

In additional embodiments, the systems and methods may be applied to the treatment of aqueous streams that contain radioactive metal ions. Representative examples may include cesium-137, strontium-90, uranium ions, and thorium ions present in reactor waste streams, spent fuel pool water, or contaminated groundwater. In some aspects, PIMIRS may be added to such streams under controlled pH and temperature conditions to reduce and precipitate the radionuclide ions as metal-oxide or metal-hydroxide crystals associated with, or subsequently separated from, the PIMIRS. In further aspects, the resulting radionuclide-containing crystals may be collected and incorporated into glass, ceramic, or other immobilization matrices for long-term storage or vitrification.

The described systems and methods may utilize a configuration where algae-derived materials are incorporated to enhance metal recovery efficiency. This configuration may involve the interaction of metal ions with biologically active sites on algae-based components, facilitating the adsorption and subsequent recovery of metals. The system may be designed to operate under a range of environmental conditions, ensuring robust performance across different operational settings.

Furthermore, the methods may include steps for processing algae to maximize the extraction and functionality of the active components used in metal recovery. This processing may involve specific treatments to increase the surface area and reactivity of the algae-derived materials. Techniques such as enzymatic digestion, mechanical disruption, or chemical treatment may be employed to achieve the desired modification of the algae components.

Additionally, the formulations may be optimized for selective recovery of metals, with specific components included to enhance the selectivity for certain metal ions over others. This selective recovery is critical in applications where a high degree of purity is required, such as in the recycling of precious metals from electronic waste. The formulations may include chelating agents, pH adjusters, and other modifiers that tailor the interaction between the metal ions and the algae-based recovery agents.

The systems may also be equipped with features that allow for the continuous operation and automation of the metal recovery process. These features may include flow controllers, pH sensors, and temperature management systems that regulate the process conditions in real time. Automation may extend to the integration of feedback loops that adjust the dosing of recovery agents and other process parameters to optimize the efficiency and effectiveness of metal recovery.

In some aspects, a process control system may include a feedback loop in which one or more sensors measure pH, temperature, metal ion concentration, flow rate, or turbidity at one or more points in the treatment train, and a controller adjusts the addition rate of PIMIRS, pH modifiers, or other reagents in response. For example, an auto-titrator may be configured to maintain the pH of a metal-bearing solution within about 0.001 pH units of a setpoint by incremental addition of base or acid while PIMIRS are present in the solution. In further embodiments, the control logic may be executed by a programmable logic controller or distributed control system that receives sensor signals and operates pumps, valves, and dosing units to maintain target conditions over extended operating periods.

In further aspects, the described methods and systems represent a comprehensive approach to metal recovery, utilizing sustainable materials and advanced process design to meet the needs of various industries. The flexibility and environmental compatibility of the algae-based components make them particularly suited to modern industrial applications where sustainability is a key concern.

In still further aspects, the described systems and methods utilize algae-based components that are capable of recovering metals from solutions. These components may be derived from both living and dead algae cells, or from fragments of these cells, including the surface layers. The recovery process involves the adsorption of metal ions onto these algae-based components, where the ions are initially bound to the cellular structures. Over time, as the metal ions form crystals such as pure, single metal, metal-oxide, or metal-hydroxide crystals, they reach a critical size which allows them to naturally desorb from the algae components without the need for additional desorption agents.

The algae utilized in these compositions may specifically belong to the order Cyanidiales, which are known for their robustness and effectiveness in binding with various metal ions. The compositions may be particularly effective in selectively recovering noble metals, transition metals, and rare-earth elements, enhancing the specificity of the metal recovery process. Each crystal produced during this recovery process may contain only one metal species, ensuring the purity of the recovered metals.

Additionally, the formulations may include PIMIRS, which are derived from algae known for their high affinity to specific metals, such as REEs. These formulations may also contain chelating agents like organic acids, which help in forming stable complexes with the metals, thereby facilitating their reduction and precipitation. The presence of antioxidants in the formulations may help in preventing the oxidation of active components, thus maintaining the efficacy of the PIMIRS during storage and use.

Enzymatic treatments may be applied to the algae extracts to break down the cell walls, which increases the availability of active sites for metal binding. Surfactants may be included to improve the dispersion of PIMIRS in the metal solution, enhancing the contact between metal ions and the active components. Additionally, pH adjusters and buffering agents are used to maintain the solution at an optimal pH, which is crucial for the effective recovery of metals.

The flexibility of these systems and methods allows for their application in various settings, including continuous flow systems and environments with variable temperatures. Stabilizers may be added to prevent the aggregation of PIMIRS under flow conditions and to maintain the efficacy of the PIMIRS across a wide range of temperatures. This adaptability makes the algae-based metal recovery systems suitable for industrial applications, including the recovery of transition metals from industrial waste streams and the selective extraction of heavy metals from contaminated soil and water.

These systems and methods represent a sustainable approach to metal recovery, emphasizing environmental compatibility and the efficient use of resources. The biodegradable nature of the formulations ensures that after metal recovery, the components break down into non-toxic substances, minimizing environmental impact. This comprehensive approach leverages the natural properties of algae and innovative processing techniques to meet the growing demand for efficient and sustainable metal recovery solutions in various industrial sectors. The methods described may include the introduction of a composition into a solution containing metal ions. This composition may be derived from algae, specifically from the living or dead cells, cell fragments, or surface layers of these cells. The metal ions in the solution may interact with this composition, leading to the formation of metal crystals such as pure, single-metal crystals, metal-oxide crystals, or metal-hydroxide crystals.

These crystals may initially adsorb onto the algae-derived materials. Over time, as these crystals reach a critical size, they may naturally desorb from the algae materials without the need for a desorption reagent. This feature may allow for a more environmentally friendly recovery process as it avoids the use of additional chemicals typically employed in desorption processes.

Furthermore, the method may involve adjusting the pH of the solution to optimize the conditions for metal reduction. This adjustment may be critical in facilitating the reduction of metal ions and the subsequent formation of pure, single-metal crystals, or metal-oxide crystals, or metal-hydroxide crystals. The pH may be maintained using an auto-titrator, ensuring that the optimal pH is consistently achieved throughout the process.

In some embodiments, the algae used in the composition may belong to the order Cyanidiales, which may have a high affinity for binding with specific metals. This specificity may enhance the selectivity of the metal recovery process, allowing for the targeted recovery of valuable metals such as noble metals, transition metals, and rare-earth elements.

The method may also include a recovery step, where the pure, single-metal crystals, metal-oxide crystals, or metal-hydroxide crystals are collected after they have desorbed from the algae materials. This step may involve various separation techniques, such as filtration or centrifugation, to effectively isolate the metal crystals from the solution. The recovered metals may then be used in various industrial applications, including the manufacture of electronic components or as catalysts in chemical reactions.

In some embodiments, after metal reduction and crystal growth, PIMIRS organic material may be at least partially removed from the crystals by oxidative digestion. For example, a slurry that contains PIMIRS and metal or metal-oxide crystals may be contacted with an aqueous solution that contains about 30% hydrogen peroxide at a volume sufficient to digest the organic material while preserving the crystalline product. The mixture may be allowed to react until visible PIMIRS material is substantially degraded, and the remaining crystals may then be separated by centrifugation or filtration and washed with water or other suitable rinses to remove residual salts and digestion byproducts. In further aspects, such oxidative digestion may be combined with natural desorption to facilitate recovery of crystals that are substantially free of organic residues.

In some embodiments, a natural desorption process may occur without the use of a desorption reagent. Desorption reagents commonly used in conventional metal recovery processes may include strong acids such as hydrochloric acid, sulfuric acid, or nitric acid, strong bases such as sodium hydroxide or potassium hydroxide, chelating agents such as ethylenediaminetetraacetic acid (EDTA) or citric acid, organic solvents, or oxidizing or reducing agents. The elimination of desorption reagents may provide several advantages. Chemical costs may be reduced by avoiding the purchase and handling of desorption chemicals. Process complexity may be reduced by eliminating desorption and regeneration steps. Environmental impact may be minimized by reducing chemical waste generation and the need for waste treatment. Product purity may be enhanced by avoiding contamination of the recovered metal crystals with desorption reagent residues. Worker safety may be improved by reducing exposure to hazardous chemicals. The natural desorption mechanism enabled by the PIMIRS composition may thus provide a simpler, more economical, and more environmentally friendly metal recovery process compared to conventional adsorption-desorption systems that require chemical regeneration cycles.

In other embodiments, natural desorption of crystals may occur when gravitational forces acting on the crystals exceed the adhesion forces between the crystals and the PIMIRS surface. The gravitational force acting on a crystal may be proportional to the crystal mass, which increases with the cube of the crystal dimension, while the adhesion force may be proportional to the contact area between the crystal and the surface, which increases with the square of the crystal dimension. As crystals grow, the gravitational force may increase more rapidly than the adhesion force, eventually reaching a critical point where the crystal detaches from the surface and settles. The adhesion forces may include van der Waals forces, electrostatic interactions, and hydrogen bonding between the crystal surface and the algae-derived surface layers. Factors that may affect the force balance include crystal density, crystal morphology, surface roughness of both the crystal and the PIMIRS material, solution viscosity, and the presence of surfactants or other surface-active agents. In some embodiments, denser crystals such as metallic gold or platinum may desorb at smaller sizes compared to less dense crystals such as aluminum hydroxide or REE hydroxides. The natural desorption mechanism may eliminate the need for chemical desorption reagents such as acids, bases, chelating agents, or organic solvents, thereby simplifying the recovery process and reducing chemical consumption and waste generation. In some aspects, gentle agitation or flow conditions may assist natural desorption by providing minor mechanical forces that help overcome residual adhesion once the critical size is reached, without requiring harsh chemical treatment.

Overall, these methods may provide a sustainable and efficient approach to metal recovery, leveraging the natural properties of algae to recover valuable metals from solutions without the need for harsh chemicals or extensive processing. The algae-based compositions and formulations described herein may be utilized in various environments and conditions to facilitate the recovery of metals from solutions. The algae material, whether in the form of living or dead cells, cell fragments, or the surface layers thereof, may interact with metal ions in the solution, leading to the formation of metal crystals such as pure, single-metal crystals, metal-oxide crystals, or metal-hydroxide crystals. These crystals may initially adhere to the algae material and may naturally desorb once they reach a certain size, thereby eliminating the need for additional desorption agents.

In further aspects, the present platform provides various system configurations. For example, in one aspects, the present platform provides a system for rapid metal ion reduction, including: a reaction vessel configured to contain an aqueous solution of metal ions; a delivery system for introducing PIMIRS into the reaction vessel; a pH control system designed to adjust and maintain the pH of the solution at an optimal level for rapid metal ion reduction; a separation unit for isolating pure, single-metal crystals, or metal-oxide crystals, or metal-hydroxide crystals from the solution post-reaction.

In some aspects, the platform provides a system for cost-effective metal ion reduction, including: a reaction vessel equipped with PIMIRS; a control system designed to optimize the use of PIMIRS and minimize waste; a recovery and regeneration module for PIMIRS to facilitate their reuse in subsequent reduction cycles.

In some aspects, the platform provides a system for efficient metal ion reduction, including: a reaction vessel configured to receive an aqueous solution and PIMIRS; a pH adjustment mechanism that automatically sets and maintains the optimal pH for metal ion reduction; a single-step separation unit designed to isolate high-purity, single-metal crystals, or metal-oxide crystals, or metal-hydroxide crystals from the reaction mixture without multiple washing or purification stages.

In some aspects, the platform provides a system for rapid metal ion reduction, including: a reaction vessel configured to contain an aqueous solution of metal ions; a delivery system for introducing PIMIRS into the reaction vessel; a pH control system designed to adjust and maintain the pH of the solution at an optimal level for rapid metal ion reduction; a separation unit for isolating pure, single-metal crystals, or metal-oxide crystals, or metal-hydroxide crystals from the solution post-reaction.

In some aspects, the platform provides a system for resource-efficient metal ion reduction, including: a reaction vessel equipped with energy-efficient mixing and heating elements; a dosage control system for precise addition of PIMIRS, minimizing excess use.

In some aspects, the platform provides a system for environmentally friendly metal ion reduction, including: a reaction vessel designed to minimize energy consumption; a control system programmed to optimize the use of PIMIRS and reduce waste; a treatment unit for purifying and recycling water and other resources used in the metal reduction process.

In some aspects, the platform provides a PIMIRS system designed for automated adaptation to varying metal ion concentrations in industrial effluents, including: sensor arrays that detect changes in metal ion concentrations in real-time; a control unit programmed to adjust the PIMIRS dosage automatically based on the sensor data to maintain optimal metal recovery efficiency.

In some aspects, the platform provides a system for the integrated application of PIMIRS in industrial settings, including: a dosing unit that automatically administers PIMIRS into processing streams; a monitoring unit equipped with sensors for real-time analysis of metal ion reduction; a control unit that processes data from the monitoring unit and adjusts the PIMIRS dosing rate accordingly.

In some aspects, the platform provides a system for the production of PIMIRS from algae, including: a cultivation unit for growing algae under controlled conditions; a disruption unit designed to mechanically or chemically break down algae cells; an extraction unit that uses solvents to isolate PIMIRS from the cell debris; a purification system that refines the PIMIRS extract to achieve high purity and functionality.

In some aspects, the platform provides a system for preparing PIMIRS from algae, including: a cultivation module designed to grow algae in an optimized nutrient environment; a processing unit for extracting and isolating active components from the algae; a formulation unit that combines the active components with stabilizers and carriers to produce a ready-to-use PIMIRS product; a quality control module to ensure the consistency and efficacy of the PIMIRS product.

In some aspects, the platform provides a system for large-scale industrial application of PIMIRS, including: a modular cultivation unit scalable according to production needs; a high-capacity processing unit equipped with advanced extraction and formulation technologies; an application unit designed for efficient integration of PIMIRS into various industrial metal recovery setups.

In some aspects, the platform provides a system for optimized process control in the production and use of PIMIRS, including: a central control unit equipped with software capable of processing input from multiple sensors and executing control actions; an array of sensors distributed throughout the cultivation, extraction, and application units to continuously gather data; actuators linked to the control unit to adjust environmental conditions and process flows automatically.

In some aspects, the platform provides a system for environmentally responsible application of PIMIRS in metal recovery, including: an application unit equipped with spill containment features to prevent accidental release of PIMIRS into the environment; a monitoring system that detects and controls the concentration of PIMIRS in effluents to ensure compliance with environmental regulations.

In some embodiments, the methods and systems of preparing the PIMIRS composition may begin with culturing algae cells, particularly algae from the order Cyanidiales such as Galdieria sulphuraria. The algae may be obtained from culture collections such as the American Type Culture Collection (ATCC), the Culture Collection of Algae and Protozoa (CCAP), or other repositories, or may be isolated from natural environments such as acidic hot springs. The algae may be cultured in a growth medium suitable for acidophilic and thermophilic species. A suitable growth medium may comprise mineral salts including ammonium sulfate or sodium nitrate as a nitrogen source at concentrations of about 0.5 g/L to about 2 g/L, potassium phosphate as a phosphorus source at concentrations of about 0.1 g/L to about 0.5 g/L, magnesium sulfate at concentrations of about 0.1 g/L to about 0.5 g/L, calcium chloride at concentrations of about 0.01 g/L to about 0.1 g/L, and trace elements including iron, manganese, zinc, copper, and molybdenum. A carbon source such as glucose, sucrose, or glycerol may be provided at concentrations of about 1 g/L to about 20 g/L for heterotrophic or mixotrophic growth. The pH of the culture medium may be adjusted to acidic conditions, such as pH 1 to pH 4, preferably pH 2 to pH 3, using sulfuric acid or hydrochloric acid. The culture temperature may be maintained between about 30° C. and about 50° C., such as about 37° C. to about 42° C. For photoautotrophic growth, continuous or intermittent light may be provided at intensities ranging from about 50 μmol photons/m²/s to about 500 μmol photons/m²/s using fluorescent lamps or LEDs. The cultures may be grown in flasks, bioreactors, or open ponds with aeration or agitation to provide mixing and gas exchange. The culture duration may range from about 3 days to about 21 days, such as about 5 days to about 14 days, until the cell density reaches about 1×10⁶ cells/mL to about 1×10⁸ cells/mL.

In some embodiments, the algae cells may be harvested when the culture reaches stationary phase or when the cell density reaches a desired level, typically after about 5 days to about 14 days of growth. Harvesting may be performed by centrifugation at centrifugal forces ranging from about 1,000 g to about 10,000 g for about 5 minutes to about 30 minutes to pellet the cells. In other embodiments, harvesting may be performed by filtration using membrane filters or tangential flow filtration systems with pore sizes ranging from about 0.2 microns to about 5 microns to retain the cells while allowing the culture medium to pass through. Flocculation may also be used, where a flocculating agent such as aluminum sulfate, ferric chloride, or cationic polymers is added to aggregate the cells, followed by settling or flotation to separate the cell mass from the liquid medium. The harvested cells may be washed one or more times with deionized water or a buffer solution to remove residual culture medium components. The washed cells may be resuspended in a minimal volume of water or buffer, or may be collected as a concentrated paste or slurry for subsequent processing. In some embodiments, the harvested cell mass may contain about 5% to about 30% dry weight of cells.

In some embodiments, the harvested algae cells may be processed to obtain a composition comprising cell walls, cell membranes, or surface layers with metal ion affinity. The processing may comprise lysing the cells to disrupt the cell membrane and release intracellular contents. Cell lysis may be achieved by physical methods such as sonication, bead milling, high-pressure homogenization, freeze-thaw cycles, or osmotic shock. For example, sonication may be performed using an ultrasonic probe at frequencies of about 20 kHz to about 40 kHz with power outputs of about 100 W to about 500 W for durations of about 5 minutes to about 30 minutes, with intermittent cooling to prevent overheating. Bead milling may be performed using glass or ceramic beads with diameters of about 0.1 mm to about 1 mm in a bead mill apparatus. Freeze-thaw cycles may involve freezing the cell suspension at temperatures below about −20° C., followed by thawing at room temperature, repeated for about 3 to about 10 cycles. After lysis, the intracellular contents may be removed by washing the lysed cell material with water, buffer solutions, or mild detergent solutions, followed by centrifugation or filtration to separate the soluble intracellular components from the insoluble cell walls, membranes, and surface layers. The washing may be repeated about 2 to about 10 times until the supernatant is substantially clear. The retained cell walls, cell membranes, and surface layers may be collected by centrifugation at about 3,000 g to about 10,000 g for about 10 minutes to about 30 minutes. The resulting material may be dried by lyophilization, air drying, or oven drying at temperatures ranging from about 25° C. to about 80° C. to obtain the final PIMIRS composition as a dry powder or flake material.

In some aspects, the platform provides a system for the sustainable management of PIMIRS, including: a collection unit designed to efficiently gather spent PIMIRS from industrial processes; a regeneration unit equipped with filtration, chemical treatment, and reactivation facilities to restore the efficacy of PIMIRS; a feedback mechanism that reintroduces regenerated PIMIRS into the production cycle, minimizing waste and reducing the need for fresh PIMIRS production.

In some aspects, the platform provides a system for metal recovery using immobilized PIMIRS, including: a reactor or column containing immobilized PIMIRS on a solid support; a means for introducing metal-laden solution into the reactor and allowing sufficient contact time for metal binding; a separation mechanism to retrieve the solid support with bound metals, followed by a metal desorption process to recover pure metals.

In some aspects, the platform provides a system for transportation of PIMIRS formulations, designed to maintain formulation integrity during transit, including: specialized transportation containers equipped with temperature control systems to keep the PIMIRS within a specified temperature range; vibration damping mechanisms within the containers to minimize physical agitation of the PIMIRS during transport.

As briefly described above, the present disclosure also provides, in various aspects, methods of making and using the disclosed compositions, formulations, materials, and agents. For example, in another exemplary aspect, the present platform provides a method for recovering metal, including: an addition step of adding a material derived from the living or dead cells or cell fragments of an alga, or the surface layer of living or dead cells of an alga, to a metal solution; and a recovery step of recovering a metal from the metal solution by the material derived from the living or dead cells or cell fragments of an alga, or the surface layer of living or dead cells of an alga; wherein the metal is recovered in the form of pure, single-metal crystals, or metal-oxide crystals, or metal-hydroxide crystals, which are initially adsorbed to the said living or dead cells or cell fragments of an alga, or the said surface layer of living or dead cells of an alga, and which are eventually naturally desorbed from said living or dead cells or cell fragments of an alga, or the said surface layer of living or dead cells of an alga, without the use of a desorption reagent, once the said crystals reaches some critical size.

In some aspects, the platform provides a method for reducing metal ions to pure, single-metal crystals, or metal-oxide crystals, or metal-hydroxide crystals using PIMIRS, including: providing a solution containing metal ions; adding PIMIRS to the solution; adjusting the pH of the solution to facilitate the reduction of metal ions; allowing the metal ions to reduce to pure, single-metal crystals, or metal-oxide crystals, or metal-hydroxide crystals; separating the pure, single-metal crystals, or metal-oxide crystals, or metal-hydroxide crystals from the solution.

In some aspects, the platform provides a method for preparing a metal ion reductant from algae, including: cultivating a specified algae species known to contain metal-reducing properties; harvesting the cultivated algae at a growth stage optimized for metal ion reduction capabilities; processing the harvested algae to extract cell walls and membranes while preserving their metal-reducing properties; formulating the treated extracts into a composition suitable for use as a metal ion reductant in aqueous solutions.

In some aspects, the platform provides a method for reducing metal ions in a solution using PIMIRS, including: introducing PIMIRS into an aqueous solution containing one or more types of metal ions; adjusting the pH of the solution to a level optimal for the reduction of the metal ions by the PIMIRS; maintaining the solution under conditions favorable for the interaction between the metal ions and PIMIRS, leading to the reduction of the metal ions to pure, single-metal crystals, or metal-oxide crystals, or metal-hydroxide crystals; separating the pure, single-metal crystals, or metal-oxide crystals, or metal-hydroxide crystals from the solution.

In some aspects, the platform provides a method for reducing metal ions to pure, single-metal crystals, or metal-oxide crystals, or metal-hydroxide crystals using a biologically derived reductant, including: providing an aqueous solution containing metal ions; introducing a biologically derived reductant, specifically PIMIRS, into the solution; adjusting and maintaining the pH of the solution to optimize the reduction of metal ions by the PIMIRS; allowing the metal ions to react with the PIMIRS under controlled conditions to form pure, single-metal crystals, or metal-oxide crystals, or metal-hydroxide crystals; collecting the pure, single-metal crystals, or metal-oxide crystals, or metal-hydroxide crystals formed as a result of the reduction process.

In some aspects, the platform provides a method for rapidly reducing metal ions in a solution, including: introducing a biologically derived reductant, specifically PIMIRS, into an aqueous solution containing metal ions; adjusting the pH of the solution to a predetermined level that facilitates rapid reduction of the metal ions; allowing the metal ions to react with the PIMIRS to form pure, single-metal crystals, or metal-oxide crystals, or metal-hydroxide crystals within 24 hours.

In some aspects, the platform provides a method for producing high-purity pure, single-metal crystals, or metal-oxide crystals, or metal-hydroxide crystals using PIMIRS, including: introducing PIMIRS into an aqueous solution containing metal ions; adjusting the pH of the solution to optimize the reduction of metal ions to pure, single-metal crystals, or metal-oxide crystals, or metal-hydroxide crystals; allowing the metal ions to react with the PIMIRS under controlled conditions to form high-purity, single-metal crystals, or metal-oxide crystals, or metal-hydroxide crystals.

In some aspects, the platform provides a method for enhancing the purity of single-metal crystals, or metal-oxide crystals, or metal-hydroxide crystals formed in a metal reduction process, including: providing an aqueous solution of mixed metal ions; adding PIMIRS specifically prepared from Galdieria sulphuraria to the solution; controlling environmental factors including pH and temperature to facilitate the formation of high-purity, single-metal crystals, or metal-oxide crystals, or metal-hydroxide crystals.

In some aspects, the platform provides a method for selectively precipitating specific metal ions from a mixed metal ion solution using PIMIRS, including: introducing PIMIRS into an aqueous solution containing a mixture of different metal ions; adjusting the pH of the solution to a level that selectively facilitates the reduction of desired metal ions to pure, single-metal crystals, or metal-oxide crystals, or metal-hydroxide crystals; allowing the reaction to proceed under controlled conditions until the desired metal ions are selectively precipitated.

In some aspects, the platform provides a method for enhancing the selectivity of metal ion precipitation in a reduction process using PIMIRS, including: providing a solution with mixed metal ions; adding PIMIRS formulated to selectively bind with specific metal ions; controlling process parameters including pH, temperature, and PIMIRS concentration to maximize the selective precipitation of targeted metal ions.

In some aspects, the platform provides a method for reducing metal ions using PIMIRS with minimized processing steps, including: introducing PIMIRS directly into an aqueous solution containing metal ions without prior treatment of the solution; adjusting the pH of the solution to facilitate rapid reduction of metal ions to pure, single-metal crystals, or metal-oxide crystals, or metal-hydroxide crystals; allowing the reaction to proceed under conditions that do not require intermittent adjustments or additional processing agents.

In some aspects, the platform provides a method for enhancing the metal recovery efficiency of PIMIRS, including: incorporating specific enzyme inhibitors into the PIMIRS formulation to prevent degradation of active components during the metal recovery process; adjusting the molecular structure of the PIMIRS to increase their affinity for targeted metal ions.

In some aspects, the platform provides a method for enhancing resource efficiency in a metal ion reduction process using PIMIRS, including: utilizing PIMIRS derived from sustainably sourced algae; conducting the metal reduction process under optimized conditions that minimize the use of additional chemicals and energy; recycling the PIMIRS for multiple cycles of metal ion reduction to maximize their usage and reduce waste.

In some aspects, the platform provides a method for enhancing the adsorption efficiency of PIMIRS for metal crystal collection, including: treating PIMIRS with a surface-modifying agent that increases the surface area and active sites available for metal ion binding; introducing the treated PIMIRS into a solution containing metal ions under conditions optimized for rapid adsorption and crystal formation.

In some aspects, the platform provides a method for extracting PIMIRS from algae, including: cultivating algae known for their metal ion reduction capabilities; harvesting the algae and subjecting it to a cell disruption process to release cellular components; extracting the PIMIRS from the disrupted cell mixture using a solvent extraction process; purifying the extracted PIMIRS to remove impurities and concentrate the active components.

In some aspects, the platform provides a method for preparing PIMIRS for use in metal ion reduction, including: selecting a specific species of algae known for its metal ion reduction properties; cultivating the selected algae under conditions optimized for the production of metal-binding compounds; harvesting the algae and processing it to extract the active metal ion reductant components; formulating the extracted components into a stable PIMIRS product suitable for introduction into metal ion solutions.

In some aspects, the platform provides a method for preparing PIMIRS with improved structural attributes for efficient metal ion reduction, including: processing Galdieria sulphuraria to retain integral cell wall components that maximize surface area and provide multiple active sites for metal binding; incorporating a cross-linking agent to stabilize the structure of PIMIRS, enhancing their durability and reusability in metal reduction applications.

In some aspects, the platform provides a method for scaling up the production of PIMIRS for industrial applications, including: establishing large-scale cultivation facilities for algae known for their metal ion reduction capabilities; implementing automated harvesting and processing systems to extract and formulate PIMIRS; integrating continuous flow systems for the seamless production and application of PIMIRS in metal recovery processes.

In some aspects, the platform provides a method for automating the production and application of PIMIRS, including: implementing a computer-controlled system to manage the cultivation, extraction, and application phases of PIMIRS; utilizing sensors and feedback mechanisms to monitor critical parameters such as pH, temperature, and metal ion concentration in real-time; adjusting process variables automatically based on data received from the monitoring systems to optimize the efficiency and effectiveness of PIMIRS.

In some aspects, the platform provides a method for regenerating PIMIRS for reuse in metal ion reduction processes, including: removing PIMIRS from a reaction mixture after completion of a metal reduction process; reintroducing the regenerated PIMIRS into a new metal ion reduction process.

In some aspects, the platform provides a method for recycling PIMIRS in a continuous metal reduction system, including: implementing a cyclic system where PIMIRS are alternately used for metal reduction and regenerated in a continuous loop; monitoring the efficacy of PIMIRS in each cycle and adjusting the regeneration process parameters to optimize performance.

In some embodiments, PIMIRS may be reused in many successive reduction cycles without substantial loss of performance. For example, PIMIRS that have been contacted with a metal-bearing solution, separated along with the formed crystals, and subjected to a recovery or regeneration step may be reintroduced into fresh metal-bearing solutions for at least about 20 cycles, or at least about 40 cycles, while maintaining a high fraction of the initial metal-removal capacity. In further aspects, the processes may be carried out at or near ambient temperature and at or near atmospheric pressure, which may reduce energy consumption and facilitate high-throughput operation in continuous or semi-continuous treatment systems.

In some aspects, the platform provides a method for reducing operational costs in metal ion reduction processes using PIMIRS, including: utilizing PIMIRS derived from cost-effective, rapidly renewable algae sources; implementing a simplified process flow that reduces the need for additional chemicals and complex machinery; recycling and reusing PIMIRS to extend their operational life and reduce material costs.

In some aspects, the platform provides a method for reducing the environmental impact of metal ion reduction processes using PIMIRS, including: employing PIMIRS derived from environmentally sustainable algae sources; conducting the metal reduction process in a manner that minimizes the release of harmful by-products; implementing a waste recycling strategy to reuse or safely dispose of waste materials generated during the process.

In some aspects, the platform provides a method for enhancing safety and reducing environmental impact in the mining operations, including preventing the release of volatile organic compounds (VOCs) and other hazardous materials during the mining operations; implementing a waste management system using PIMIRS that treats and recycles waste products from the mining operations process to minimize environmental contamination.

In some aspects, the platform provides a method for recycling and reusing PIMIRS in metal recovery processes, including: collecting spent PIMIRS after metal recovery operations; reintroducing the PIMIRS into the metal recovery process or using in weak and degraded soils as a mechanism for soil rejuvenation.

In some aspects, the platform provides a method for applying PIMIRS in industrial metal recovery processes, including: introducing PIMIRS into a metal-laden aqueous solution under controlled flow conditions; monitoring the reduction process in real-time using sensors to detect metal ion concentrations; adjusting the dosage of PIMIRS dynamically based on sensor feedback to optimize metal recovery efficiency.

In some aspects, the platform provides a method for preparing PIMIRS for use in metal recovery, including: cultivating Galdieria sulphuraria under controlled conditions to achieve optimal biomass; and harvesting the biomass.

In some aspects, the platform provides a method for recovering metals using PIMIRS, including: introducing PIMIRS into a solution containing dissolved metal ions; adjusting the pH of the solution to optimize the reduction potential of the metal ions; allowing sufficient time for PIMIRS to bind and reduce the metal ions to their elemental or oxide forms; separating the metal-loaded PIMIRS from the solution; recovering the metals from PIMIRS through a gentle desorption process that preserves the integrity of both the metals and PIMIRS.

In some aspects, the platform provides a method for storing PIMIRS formulations designed to enhance stability and prolong shelf life, including: storing the PIMIRS in airtight containers made from materials that do not react with the formulation components.

In further aspects, the platform also provides compositions, system and methods for producing hydrogen. In one aspect, a method for producing hydrogen, can comprise: providing a solution containing at least one element selected from Group 1 and Group 2 of the periodic table; adjusting the pH of the solution; adding PIMIRS to the solution; precipitating a solid hydroxide of the at least one element from the solution; and releasing hydrogen gas. In some embodiments, the at least one element may comprise one or more alkali (Group 1) metals and/or one or more alkaline earth (Group 2) metals. In other embodiments, the at least one element may comprise barium and/or sodium. Adjusting the pH of the solution may comprise increasing the pH to an alkaline level. The PIMIRS may comprise nanostructures, and/or the nanostructures may comprise metal-oxide nanoparticles. The method may further comprise collecting the released hydrogen gas, and/or separating the solid hydroxide from the solution.

In another aspect, a method for generating hydrogen using PIMIRS may comprise: preparing an aqueous solution containing a Group 1 or Group 2 element; modifying the pH of the aqueous solution; introducing PIMIRS into the aqueous solution; inducing precipitation of a hydroxide of the Group 1 or Group 2 element; and producing hydrogen gas as a result of the precipitation. In some embodiments, the Group 1 or Group 2 element may comprise one or more alkali (Group 1) metals and/or one or more alkaline earth (Group 2) metals. In other embodiments, the Group 1 or Group 2 element comprises barium and/or sodium. Modifying the pH comprises raising the pH to a basic level. The PIMIRS comprise nanoscale structures, and wherein the nanoscale structures may comprise metal oxide nanoparticles. The method may further comprise harvesting the produced hydrogen gas.

In another aspects, a method of utilizing PIMIRS for hydrogen production may comprise: forming a solution containing at least one alkali (Group 1) metal or alkaline earth (Group 2) metal; adjusting the solution to a target pH; dispersing PIMIRS in the solution; facilitating formation of a metal hydroxide precipitate; and liberating hydrogen gas concurrent with the formation of the metal hydroxide precipitate. In some embodiments, the at least one alkali (Group 1) metals or alkaline earth (Group 2) metals may comprise one or more alkali (Group 1) metals and/or one or more alkaline earth (Group 2) metals. In other embodiments, the at least one alkali (Group 1) metal or alkaline earth (Group 2) metal may comprise barium and/or sodium. Adjusting the solution to a target pH comprises increasing the pH to an alkaline value.

In another aspect, a system for producing hydrogen gas may comprise: a reaction vessel configured to contain a solution comprising at least one element selected from Group 1 and Group 2 of the periodic table; a pH adjustment mechanism configured to adjust the pH of the solution; a PIMIRS delivery mechanism configured to add PIMIRS to the solution; and a gas collection mechanism configured to collect hydrogen gas released from the reaction vessel. The system may further comprise a solid-liquid separation mechanism configured to separate precipitated solid hydroxide from the solution. The PIMIRS delivery mechanism may comprise a dispenser for dispensing PIMIRS nanoparticles. The pH adjustment mechanism may comprise a chemical dosing unit. The system may further comprise a light source configured to irradiate the solution containing the PIMIRS.

In another aspect, a composition for hydrogen gas production may comprise: a solution containing at least one element selected from Group 1 and Group 2 of the periodic table; and PIMIRS dispersed in the solution. The at least one element may comprise barium and/or sodium. The PIMIRS may comprise metal oxide nanoparticles. The solution may have an alkaline pH.

In another aspect, a method for simultaneous production of hydrogen gas and metal hydroxide may comprise: preparing a solution containing at least one metal ion selected from Group 1 and Group 2 of the periodic table; introducing PIMIRS into the solution; irradiating the solution containing the PIMIRS; and collecting hydrogen gas evolved from the solution while a metal-hydroxide precipitates. The metal ion may be selected from the group consisting of barium ions and sodium ions.

In various further aspects, the detailed description of these embodiments underscores the potential of algae-based materials in providing an efficient, selective, and environmentally friendly solution to metal recovery challenges. These methods, systems, and compositions may be particularly advantageous in industries where metal recovery is crucial, such as in the recycling of electronic waste or in the mining industry. The method of introducing a material derived from algae to a metal solution may facilitate the selective recovery of metals. This process may involve the addition of algae-based materials to the metal solution, where the metals may be adsorbed onto the algae material. Subsequently, the metals may be recovered from the solution in the form of pure, single-metal crystals, metal-oxide crystals, or metal-hydroxide crystals. The recovery may occur without the use of a desorption reagent, which may be beneficial for reducing chemical use and enhancing environmental sustainability.

In still further aspects, additional contemplated applications may include removal of zirconium and hafnium from ore leachates, separation of thorium and uranium from rare-earth element process streams, and preparation of metal-oxide crystal feedstocks for incorporation into vitrified nuclear waste forms. For example, PIMIRS may be contacted with a solution that contains zirconium and hafnium ions to produce discrete zirconium-oxide and hafnium-oxide crystals that may be physically separated and handled as individual products. In further embodiments, thorium and uranium ions may be reduced and precipitated as oxide crystals prior to, during, or after recovery of rare-earth elements from the same solution, thereby providing flexibility in process design for nuclear fuel cycle and waste-treatment applications.

### D. EXAMPLES

The following examples are put forth so as to provide those of ordinary skill in the art with a complete disclosure and description of how the compounds, compositions, articles, systems, and/or methods claimed herein are made and evaluated and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The Examples are provided herein to illustrate the invention and should not be construed as limiting the invention in any way. Examples are provided herein to illustrate the invention and should not be construed as limiting the invention in any way.

### 1. Plant Induced Metal Ion Reductants (PIMIRS)

In this Example, Plant Induced Metal Ion Reductants (PIMIRS) were verified in quantitatively and rapidly reducing all rare earth element (REE) metal ions into pure, single-metal crystals, or metal-oxide crystals, or metal-hydroxide crystals.

The growing process for PIMIRS began on a small scale and was adjusted for optimal growth rates: 30 to 40 g/gal harvested at 33% solids. Two gallons were harvested and frozen per day. Approximately 5 mg-60 mg of PIMIRS were used per REE test on a 10 mL sample.

In some embodiments, PIMIRS may be produced at scale using tissue-culture or bioreactor systems in which algae are grown under controlled temperature, light, and nutrient conditions. For example, a cultivation system with an effective working volume of at least about 1,900 liters may be configured to maintain growth rates that yield from about 30 g to about 40 g of harvested biomass per gallon of culture per day at about 33% solids after dewatering. In further aspects, the culture may be harvested continuously or semi-continuously, and the biomass may be frozen or otherwise preserved for later use as PIMIRS. The growth medium may be recycled or supplemented between harvests and, after appropriate conditioning, may optionally be used as a fertilizer or soil amendment.

In some aspects, useful dose ranges for PIMIRS relative to the mass of metal ions present in solution may be defined. For example, in representative REE tests, about 5 mg to about 60 mg of PIMIRS may be contacted with about 10 mL of solution containing up to about 1,000 mg/L of each REE. In other embodiments, dose ratios in a range from about 0.1 mg of PIMIRS per mg of total metal ions to about 10 mg of PIMIRS per mg of total metal ions may be used, depending on the desired reaction time and completeness of reduction. In further aspects, a person of ordinary skill in the art may select suitable PIMIRS-to-metal mass ratios based on empirical measurements of removal efficiency under the intended operating conditions.

A library was created to begin categorization and identification of all the REE pure, single-metal crystals, or metal-oxide crystals, or metal-hydroxide crystals formed by PIMIRS. Methods for removing and recovering PIMIRS from the REE crystals were investigated. Economic growth, production and storage of PIMIRS were also explored.

Equipment for processing and analyzing metal crystal purity and quantity was either purchased or secured for use: Auto-titrator, TCS SPS II Confocal Electron Microscope (CEM), X-Ray Fluorescence Electron Microscope (EDS), Atomic Force Microscope (AFS) and/or an X-Ray Diffraction Electron Microscope (XRD). Absolute quantitative analyses were performed using the Thermo-Finnigen Neptune Multi-Collector Inductively Coupled Plasma Mass Spectrometer (ICP-OES). Electron Microscopes tend to ignore the presence of any PIMIRS in low concentrations. The ion to pure, single-metal crystals, or metal-oxide crystals, or metal-hydroxide crystals conversions were concentration independent [concentrations as high as 10,000 ppm (mg/L, grams/tonne) of each REE examined].

In some embodiments, the reduction of metal ions by PIMIRS may be substantially independent of the starting concentration of the ions over a broad range. For example, the PIMIRS may reduce REE ions from concentrations as low as about 1 part per billion up to at least about 10,000 ppm, or about 100,000 ppm, while still producing discrete, pure, single-metal crystals, or metal-oxide crystals, or metal-hydroxide crystals. In other embodiments, similar concentration-independent behavior may be observed for toxic metal ions such as arsenic or selenium, for transition metals, and for radionuclides. In further aspects, the mass of metal that can be converted to crystals per unit mass of PIMIRS may scale with input concentration while preserving the crystal morphology and purity.

Commercially available standard REE solution (containing 16 REEs) was used to test whether or not the PIMIRS could reduce the elements in their ionic state out of the solution in the form of pure, individual metal-metal crystals, or metal-oxide crystals, or metal-hydroxide crystals. Usually, it is cost efficient to start at the REE solution's original pH level. Various pH levels were tested to determine if purification and crystallization of individual REEs was possible based on a targeted pH level (e.g., 1.8, 3.0, 3.5, 6.0, 8.0, and 10.0). More pH tests were performed to determine if individual REEs or groups of REEs could be removed independently or targeted separately.

In some embodiments, the extent and selectivity of metal ion reduction by PIMIRS may depend on pH and on the presence or absence of chelating agents. For example, tests performed with rare-earth element standard solutions at pH values of about 1.8, about 3.0, about 3.5, about 6.0, about 8.0, and about 10.0, with and without chelators such as ethylenediaminetetraacetic acid, 1,10-phenanthroline, or sodium tripolyphosphate, may show that strong chelating agents can inhibit reduction of some metal ions, whereas other ligands may not prevent crystal formation. In further aspects, a person of ordinary skill in the art may select pH windows and chelator compositions that permit reduction and precipitation of desired target metals while maintaining other metals in solution when selective removal is preferred.

The standard solution of metal-ions contained 1000 mg/L of each of the 16 REES suspended in 4% HNO₃. A 10.0 mL aliquot was placed into a 50 mL plastic test-tube and the pH level was adjusted to an initial desired pH (1.8 or 3.0, etc., as stated above). An appropriate amount of PIMIRS was added, while stirring, and the desired pH was maintained by an auto-titrator that added increments of NaOH or NH₄OH to maintain the selected pH until equilibrium was reached. The pH levels were maintained by the use of an auto-titrator that could maintain the pH to 1/1000th of a pH unit. Both bases, NaOH and NH₄OH were used, with the NH₄OH being the most effective. Also, the NH₄OH had the additional benefit of presenting the least interference with the ICP-OES analyses due to the absence of the “sodium-flame” flare in the torch of the ICP-OES flame.

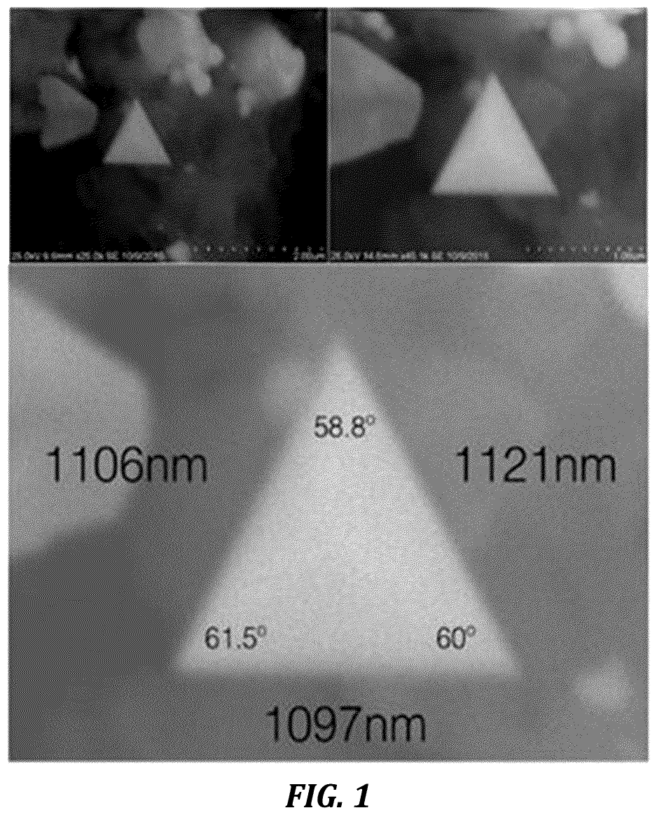

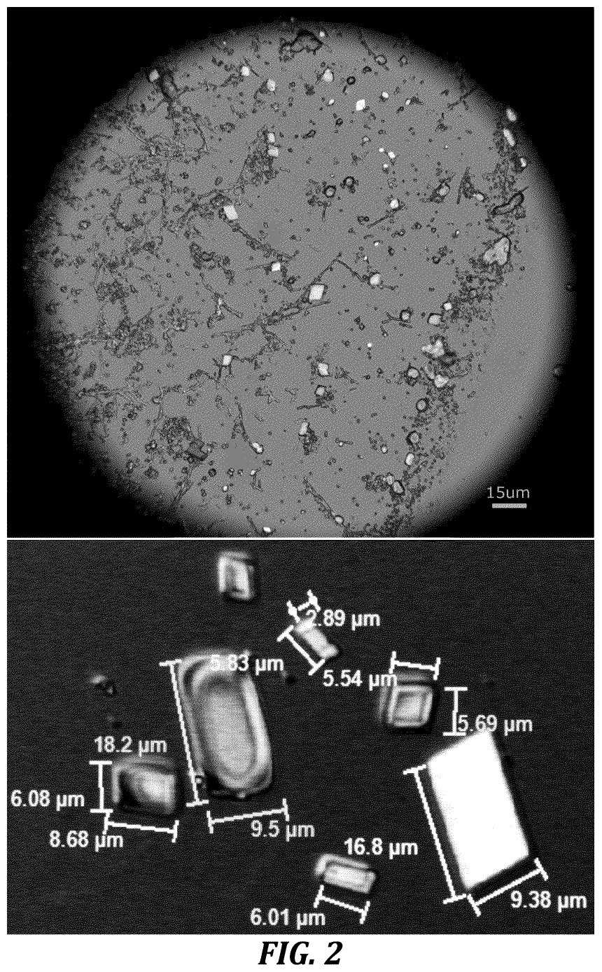

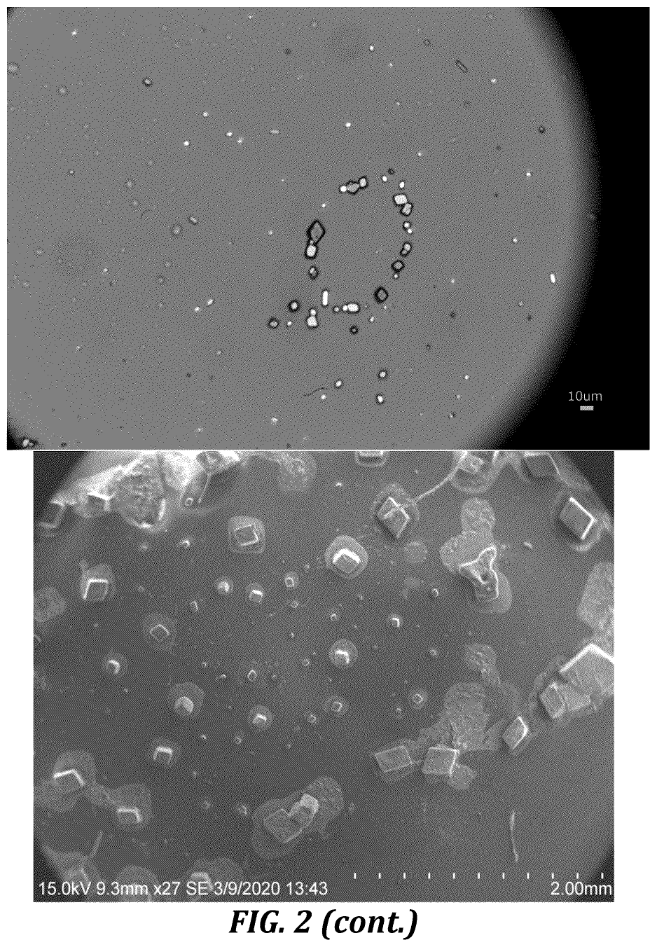

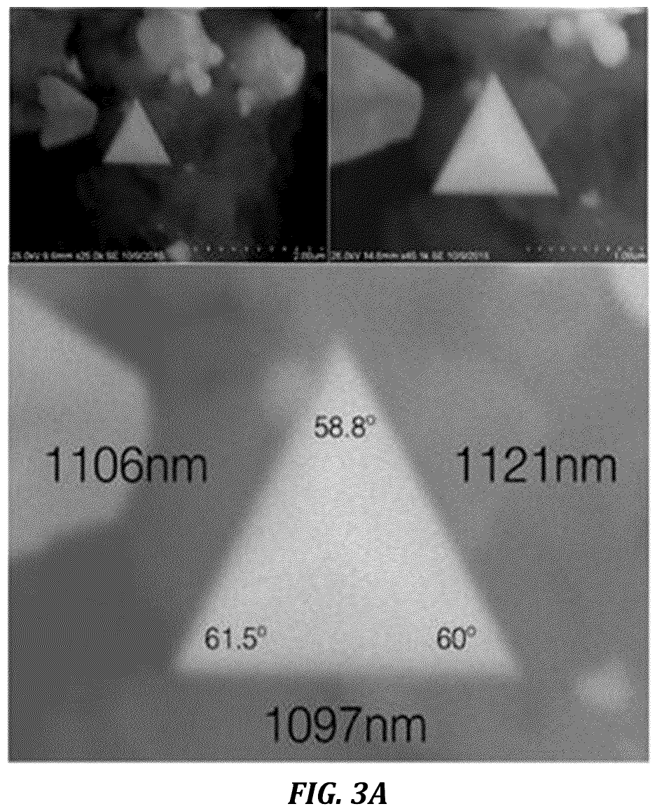

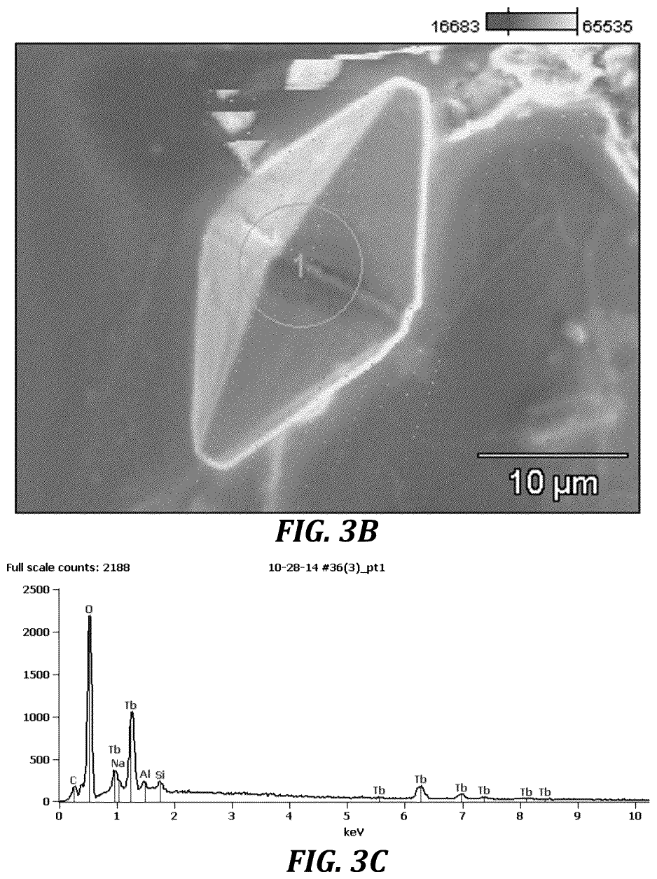

After equilibrium was reached, the sample was centrifuged or filtered to remove PIMIRS and the REE pure, single-metal crystals, or metal-oxide crystals, or metal-hydroxide crystals. The clear solution remaining (supernatant or filtered) was analyzed using an ICP-OES to determine the concentration of any of the REE metal-ions that had not been reduced. The absence of REE metal-ions within the supernatant or filtrate suggested that the REEs formed a pellet of pure, single-metal crystals, or metal-oxide crystals, or metal-hydroxide crystals. Within 24-hours of each test, PIMIRS extracted all 16 of the REE crystals equally at the tested pHs. (Initially, the REE crystals were separated from solution using only filters. Filter sizes required for the separation of standard REE crystals were determined to be 10 microns, 1 micron, and 0.1 microns. Single-metal crystals, or metal-oxide crystals, or metal-hydroxide crystals, in general are in the 20-30 microns range. The 0.1 microns filter would be used after centrifugation for ICP-OES analyses.) The filtered filtrate was tested using an ICP-OES. The results for pH tests above 4.0 showed that PIMIRS had successfully converted 99+% of the REE ions into pure, single-metal crystals, or metal-oxide crystals, or metal-hydroxide crystals. However, at pH levels lower than 4.0, the filter's integrity was destroyed, and results could not be verified without centrifuging. Therefore, centrifuging was used to remove crystals from pH levels less than 4.0. The remaining supernatant was tested with the ICP-OES. With no evidence of pH partitioning, the results of the ICP-OES tests showed that PIMIRS had successfully converted 99+% of the REE ions of all 16 REEs into pure, single-metal crystals, metal-oxide crystals, or metal-hydroxide crystals within 0-24 hours at all pH levels. Examples of pure triangular gold crystals produced from a solution using PIMIRS are shown in FIG. 1. Examples of various crystals of rare-earth compounds precipitated using PIMIRS are shown in FIG. 2. Examples of crystal of terbium compound and associated X-ray trace, following precipitation using PIMIRS are shown in FIG. 3A, a larger version of crystal shown in FIG. 3A is shown in FIG. 3B, and a graph of larger version of X-ray trace is shown in FIG. 3C.

In some embodiments, the crystals produced by PIMIRS may have characteristic size ranges and morphologies that can be influenced by operating conditions. Representative crystals may have average dimensions in a range from about 2 microns to about 125 microns, such as from about 20 microns to about 30 microns, and may exhibit shapes that include triangular plates, rectangular prisms, rods, or aggregates of such forms. In further aspects, parameters such as pH, reaction time, PIMIRS dose, temperature, and agitation rate may be adjusted to favor the growth of crystals within a particular size range that is suitable for downstream separation by filtration, centrifugation, sieving, or flotation.

### 2. Method for Using PIMIRS to Recover Rare Earth Elements and Other Metals From Ores

In this Example, Plant Induced Metal Ion Reductants (PIMIRS) are used to remove and concentrate rare earth elements (REEs) and other metals from ores.

First, ore is ground to 400 mesh, or smaller, to increase the surface to volume ratio in particle size. Next, using a heap-leach-type technique, the ore was treated with acid to dissolve the metals into forming a slurry of metal-ions. The metallic ion slurry is then clarified by either filtration, centrifugation, or by settling. The clarified metallic-ion-containing solution is ready for conversion into individual metallic metal crystals using the PIMIRS reducing-compound technology.

In some embodiments, the clarified metallic-ion solution may derive from heap-leach operations that use acidic lixiviants, such as sulfuric acid, to extract metals from crushed ore at pH values in a range from about 0.8 to about 3.0. In further aspects, PIMIRS may be added directly to such heap-leach solutions, or to raffinate or pregnant leach solutions from solvent-extraction or ion-exchange circuits, to recover REEs and other metals as substantially pure, single-metal crystals, or metal-oxide crystals, or metal-hydroxide crystals. In some embodiments, a single contact stage with PIMIRS may remove at least about 40% to at least about 99% of one or more target metals from such industrial leachates, and additional contact stages may be used to further reduce the residual metal content.

In some embodiments, PIMIRS may be used as a collector or co-collector in flotation processes that treat metal-bearing ores or concentrates. For example, PIMIRS may be added to an ore pulp in a flotation cell, such as a Denver cell, under conditions that promote attachment of PIMIRS and associated metal or metal-oxide crystals to rising bubbles. The resulting froth may be collected as a pre-concentrate that contains enriched levels of target metals. In further aspects, the PIMIRS dosage, pH, and aeration rate may be selected to enhance recovery of rare-earth elements, precious metals, or other target metals while reducing entrainment of gangue minerals.

Next, each chemical, metallic element has its own optimal pH for reduction by the PIMIRS. Therefore, the clarified, metallic-ion solution, using an autotitrator, may be set at pH 1.8* initially [using concentrated ammonium hydroxide (in microliter amounts) for ALL REEs. The autotitrator used was an SI Analytics, Titroline 6000/7000, Mainz, Germany, purchased from VWR Laboratory Supply]. The analytical procedure involved the placing of 10.0 mL of the metallic-ion solution [to ~100,000 ppm (mg/L)] into a 50 mL plastic test-tube [Falcon tube] and adjusting its pH to 1.8 until stabilized with the very dilute (in the 0.0025 mM range) base, ammonium hydroxide. After the targeted pH was reached, ~40 mg of the frozen PIMIRS (~33% solids) were added to a 10 mL sample of the test-solution [placed into a 50 mL Falcon (or similar tube), and the pH was maintained by stirring with a very tiny magnetic stirrer bar (VWR CAT. NO. 58948-353—2 have been enclosed) until equilibrium was reached (no further pH changes were occurring). Equilibrium was reached within 24 to 48 hours for the REEs. The next sample then was placed into the titrator and the process was repeated.

Next, the metallic crystals can then be separated by standard electrophoretic technique used for solvent extraction procedures. For this Example, conversion and recovery rate was 100%, with a metal-crystal purity of 100%.

In some embodiments, it was observed that the recovered metal REE crystals may have different sizes and shapes, and may have different polarized coloration. As such, the creation of a particle-separator for REEs may be performed next.

According to various embodiments, the present disclosure includes at least the following aspects: In one aspect, a composition for selective metal recovery includes a material derived from living or dead cells, cell fragments, or surface layers of living or dead cells, or a combination thereof, of an alga, wherein, upon contact of the material with a metal-ion-containing aqueous solution, one or more metals from the solution are recovered in the form of substantially single-metal crystals selected from metal crystals, metal-oxide crystals, and metal-hydroxide crystals, the crystals being initially adsorbed to the living or dead cells or cell fragments or the surface layer of the living or dead cells, and being naturally desorbed from the living or dead cells or cell fragments or the surface layer of the living or dead cells without use of a desorption reagent once the crystals reach a critical size.

In another aspect, the alga belongs to the order Cyanidiales. In another aspect, the composition selectively recovers one or more noble metals, one or more transition metals, or one or more REEs, or a combination thereof. In another aspect, each crystal produced is predominantly composed of a single metal species.

In another aspect, a formulation of PIMIRS for selective recovery of metals from aqueous solution includes a base composition including biologically derived material obtained from algae and containing cell walls, membranes, or surface layers having affinity for metal ions, and one or more pH-adjusting agents configured to establish and maintain a pH range suitable for reduction of REE ions to substantially single-metal metal-oxide crystals.

In another aspect, the base composition is derived from algae known for high affinity to REEs.

In another aspect, the pH-adjusting agents are selected to enable rapid response to changes in solution acidity during a metal recovery process.

In another aspect, the formulation further includes one or more stabilizers that inhibit aggregation of the PIMIRS in a flowing aqueous solution.

In another aspect, the formulation further includes one or more buffering agents configured to maintain the aqueous solution within an optimal pH range for metal recovery.

In another aspect, the composition or formulation is configured for recovery of transition metals from industrial waste streams and the base composition includes an extract from algae having a high affinity for transition metals.

In another aspect, the formulation is configured for selective extraction of heavy metals from contaminated soil or water.

In another aspect, the formulation further includes one or more surfactants configured to improve dispersion of the PIMIRS in aqueous solutions and enhance contact between the PIMIRS and metal ions.

In another aspect, the composition or formulation is configured for multi-metal recovery from a mixed metal solution.

In another aspect, the formulation includes modifiers including pH adjusters that enable the PIMIRS to function in environments having varying acidity or alkalinity.

In another aspect, the formulation further includes a binding enhancer that increases physical stability of a PIMIRS-metal complex and facilitates separation and purification of recovered metals.

In another aspect, the composition or formulation is characterized by rapid metal ion reduction and includes a blend of plant extracts configured to provide fast electron transfer to metal ions in solution.

In another aspect, the plant extracts are derived from algae species having high electron donor-acceptor properties.

In another aspect, the formulation further includes a stabilizing agent that preserves active reducing sites of the PIMIRS over a range of pH conditions.

In another aspect, the composition or formulation is characterized by enhanced electron transfer capability and includes a blend of plant extracts from Galdieria sulphuraria.

In another aspect, the formulation further includes an electron mediator that facilitates transfer of electrons between the PIMIRS and metal ions in solution.

In another aspect, the formulation further includes pH adjusters configured to establish and maintain a pH range that enhances electron transfer between the PIMIRS and metal ions during metal reduction.

In another aspect, the formulation further includes a conductivity enhancer that increases ionic conductivity of a metal-ion-containing aqueous solution contacted with the formulation, thereby increasing a rate at which the PIMIRS reduce the metal ions to substantially single-metal crystals.

In another aspect, the composition or formulation is characterized by rapid metal ion reduction and includes a blend of plant extracts configured to provide fast electron transfer to metal ions in solution.

In another aspect, the plant extracts are derived from algae species having high electron donor-acceptor properties.

In another aspect, the formulation further includes a stabilizing agent that preserves active reducing sites of the PIMIRS over a range of pH conditions.

In another aspect, the composition or formulation is characterized by enhanced electron transfer capability and includes a blend of plant extracts from Galdieria sulphuraria.

In another aspect, the formulation further includes an electron mediator that facilitates transfer of electrons between the PIMIRS and metal ions in solution.

In another aspect, the formulation further includes pH adjusters configured to establish and maintain a pH range that enhances electron transfer between the PIMIRS and metal ions during metal reduction.

In another aspect, the formulation further includes a conductivity enhancer that increases ionic conductivity of a metal-ion-containing aqueous solution contacted with the formulation, thereby increasing a rate at which the PIMIRS reduce the metal ions to substantially single-metal crystals.

In another aspect, the conductivity enhancer is selected to facilitate bidirectional electron transfer between the PIMIRS and the metal ions, enhancing both transfer of electrons from the PIMIRS to the metal ions and transfer of charge from the metal ions to the PIMIRS during crystal nucleation and growth.

In another aspect, the formulation further includes a buffering agent configured to maintain the aqueous solution within a pH range selected to optimize electron transfer between the PIMIRS and the metal ions during metal recovery.

In another aspect, the formulation further includes an antioxidant agent that inhibits oxidative degradation of electron-donating functional groups within the PIMIRS during storage and use.

In another aspect, the electron mediator is covalently or non-covalently coupled with a fluorescent marker configured to change fluorescence intensity or wavelength in response to a redox state of the mediator, thereby enabling in-line optical monitoring of electron transfer during metal recovery.

In another aspect, the fluorescent marker is selected to emit at a wavelength that does not interfere with other optical monitoring systems in use.

In another aspect, the electron mediator is regenerable through exposure to a reducing agent after completion of a metal recovery cycle.

In another aspect, the formulation further includes a chelating agent that enhances selectivity of the PIMIRS for specific metal ions.

In another aspect, the conductivity enhancer includes an ionic liquid that remains stable over a wide pH range.

In another aspect, the algae belong to the order Cyanidiales.

In another aspect, the algae material or extracts are derived from the red-alga species Galdieria sulphuraria.

In another aspect, the composition or formulation selectively recovers one or more noble metals, one or more transition metals, or one or more REEs.

In another aspect, each crystal produced is predominantly composed of a single metal species.

In another aspect, “predominantly composed of a single metal species” means that a single metal species constitutes at least about 95% by weight of each crystal.

In another aspect, the single metal species constitutes at least about 99% by weight of each crystal.

In another aspect, a method for recovering metal from an aqueous metal-ion-containing solution includes adding to the solution a material derived from living or dead cells, cell fragments, or surface layers of living or dead cells of an alga, and recovering metal from the solution by adsorption of metal ions onto the material and formation of substantially single-metal crystals selected from metal crystals, metal-oxide crystals, and metal-hydroxide crystals, wherein the crystals are initially adsorbed to the living or dead cells or cell fragments or the surface layer of the living or dead cells, and are naturally desorbed from the living or dead cells or cell fragments or the surface layer of the living or dead cells without use of a desorption reagent once the crystals reach a critical size.

In another aspect, the alga belongs to the order Cyanidiales.

In another aspect, the recovering includes selectively recovering one or more noble metals, one or more transition metals, and one or more rare earth elements.

In another aspect, the crystals produced are predominantly composed of a single metal species.

In another aspect, the material is derived from algae of the species Galdieria sulphuraria.

In another aspect, the pH is maintained using an auto-titrator.

In another aspect, the substantially single-metal crystals formed have an average size in a range from about 20 microns to about 30 microns.

In another aspect, the solution includes one or more REE ions.

In another aspect, the method further includes using the substantially single-metal crystals in manufacture of electronic components.

In another aspect, the algae are harvested when at a biomass concentration that maximizes the yield of cell walls and membranes with metal-reducing properties.

In another aspect, the material is treated by adjusting the pH to stabilize metal-reducing compounds within the cell walls and membranes.

In another aspect, a method for reducing metal ions in an aqueous solution using PIMIRS includes introducing PIMIRS into an aqueous solution containing one or more types of metal ions, adjusting a pH of the aqueous solution to a level suitable for reduction of the one or more metal ions by the PIMIRS, maintaining the aqueous solution under conditions favorable for interaction between the one or more metal ions and the PIMIRS to form substantially single-metal crystals selected from metal crystals, metal-oxide crystals, and metal-hydroxide crystals, and separating the substantially single-metal crystals from the aqueous solution.

In another aspect, the PIMIRS are derived from algae of the species Galdieria sulphuraria.

In another aspect, the pH is controlled using an auto-titrator to maintain the pH within a range that optimizes reduction efficiency of the PIMIRS.

In another aspect, the method further includes stirring the aqueous solution to promote uniform distribution of the PIMIRS and contact with the one or more metal ions.

In another aspect, the method further includes using the substantially single-metal crystals in one or more subsequent chemical reactions.

In another aspect, the metal ions are reduced by the PIMIRS to form substantially single-metal crystals selected from metal crystals, metal-oxide crystals, and metal-hydroxide crystals, and the substantially single-metal crystals are collected from the solution.

In another aspect, the PIMIRS are derived from algae of the species Galdieria sulphuraria.

In another aspect, the pH of the solution is maintained using an automated titration system that adjusts the pH in real time during reduction of the metal ions by the PIMIRS.

In another aspect, the solution is agitated and maintained at a temperature suitable for efficient reduction of the metal ions by the PIMIRS.

In another aspect, the substantially single-metal crystals are separated from the solution using a filtration process that retains the crystals and allows the PIMIRS and dissolved species to pass through.

In another aspect, the method further includes regenerating the PIMIRS after separation from the substantially single-metal crystals and reusing the regenerated PIMIRS in a subsequent metal ion reduction process.

In another aspect, the substantially single-metal crystals produced have a purity sufficient for use in high-precision applications selected from semiconductor manufacturing and catalysis.

In another aspect, the metal ions are reduced by the PIMIRS to form substantially single-metal crystals within 24 hours after adding the PIMIRS to the solution.

In another aspect, a predetermined pH level is maintained using an auto-titrator.

In another aspect, the substantially single-metal crystals formed are predominantly composed of one or more rare earth elements.

In another aspect, the method further includes drying the substantially single-metal crystals after separation from the solution.

In another aspect, the solution is maintained at a temperature in a range from about 35° C. to about 45° C. during reduction of the metal ions.

In another aspect, the metal ions are reduced at approximately ambient temperature.

In another aspect, the metal ions include a mixture of transition metal ions and REE ions.

In another aspect, the reduction results in substantially single-metal crystals with a purity suitable for industrial use.

In another aspect, the aqueous solution contains metal ions at a concentration of at least about 100,000 ppm.

In another aspect, the aqueous solution contains metal ions at a concentration in a range from about 1,000 ppm to about 100,000 ppm.

In another aspect, the method further includes using the substantially single-metal crystals in manufacture of electronic components.

In another aspect, the PIMIRS are regenerated after separation from the substantially single-metal crystals and reused in at least one subsequent metal ion reduction process.

In another aspect, the substantially single-metal crystals have an average size in a range from about 1 micron to about 80 microns.

In another aspect, the substantially single-metal crystals have an average size in a range from about 10 microns to about 50 microns.

In another aspect, the substantially single-metal crystals have an average size in a range from about 20 microns to about 40 microns.

In another aspect, the PIMIRS are added to the solution in a freeze-dried form to enhance their reactivity.

In another aspect, the PIMIRS are derived from algae species known for their high metal-binding affinity.

In another aspect, the pH is adjusted to a value between about 1.5 and about 3.5 to enhance formation of substantially single-metal crystals.

In another aspect, the substantially single-metal crystals are primarily composed of REEs.

In another aspect, the method further includes isolating the substantially single-metal crystals from the solution using a centrifugation process.

In another aspect, the solution is agitated continuously to ensure uniform distribution of PIMIRS and contact with metal ions.

In another aspect, the substantially single-metal crystals are used in fabrication of precision electronic devices.

In another aspect, the PIMIRS are regenerated and reused for subsequent batches to maintain efficiency in metal ion reduction.

In another aspect, the method further includes processing the substantially single-metal crystals to adjust their size and shape for specific industrial applications.

In another aspect, the substantially single-metal crystals are separated from the solution using a microfiltration technique that retains the crystals while allowing smaller impurities to pass through.

In another aspect, the substantially single-metal crystals are dried using a controlled low-temperature drying process to reduce aggregation and maintain purity.

In another aspect, a purity of the substantially single-metal crystals is verified using spectroscopic analysis techniques.

In another aspect, the PIMIRS are formulated to target reduction of a selected group of metal ions, enhancing purity of the resulting substantially single-metal crystals.

In another aspect, environmental factors of the reaction, including pH and temperature, are monitored and adjusted in real time using automated systems.

In another aspect, the PIMIRS are added in a proportion calculated based on an initial concentration of metal ions in the solution.

In another aspect, the substantially single-metal crystals have a purity level of at least about 99%.

In another aspect, the pH is adjusted to a specific range that is optimal for precipitation of REEs while minimizing precipitation of other metals.

In another aspect, the PIMIRS are derived from algae species that have a high affinity for selected metal ions, enhancing selectivity of the precipitation process.

In another aspect, the method further includes isolating selectively precipitated substantially single-metal crystals using a filtration process designed to separate them based on size or density.

In another aspect, a selective precipitation process is monitored using spectroscopic methods to assess purity and specificity of substantially single-metal crystals formed.

In another aspect, the solution contains metal ions from industrial waste streams and the process selectively recovers valuable metals for recycling.

In another aspect, selective precipitation is used to purify solutions in environmental cleanup operations, targeting specific pollutant metals for removal.

In another aspect, controlled process parameters are adjusted dynamically based on real-time analysis of a metal ion composition in the solution.

In another aspect, the PIMIRS are pre-formulated to be compatible with a wide range of metal ion concentrations, thereby reducing a need for concentration adjustment of the solution.

In another aspect, the reaction is carried out at approximately room temperature.

In another aspect, the method further includes recovering substantially single-metal crystals through a filtration process without centrifugation.

In another aspect, the PIMIRS are formulated such that their interaction with the solution reduces a need for external pH adjustment.

In another aspect, introduction of PIMIRS and adjustment of pH are performed simultaneously.

In another aspect, the PIMIRS are regenerated within a reaction vessel for reuse without removal from the reaction vessel.

In another aspect, the PIMIRS are stored in a lyophilized form and reconstituted immediately before use.

In another aspect, the solution is maintained under inert atmosphere to prevent oxidation of the PIMIRS during metal ion reduction.

In another aspect, the substantially single-metal crystals are characterized by X-ray diffraction to confirm their crystalline structure.

In another aspect, the PIMIRS are formulated with a protective coating that enhances their stability in acidic solutions.

In another aspect, the metal ions are selectively reduced in a sequential manner by adjusting the pH stepwise.

In another aspect, the substantially single-metal crystals are collected using magnetic separation when the crystals include magnetic metals.

In another aspect, the PIMIRS are formulated with a stabilizer that prevents degradation during extended storage periods.

In another aspect, the substantially single-metal crystals are analyzed using scanning electron microscopy to assess morphology.

In another aspect, the solution is filtered through a membrane with a pore size selected to retain the substantially single-metal crystals while allowing dissolved impurities to pass.

In another aspect, the PIMIRS are derived from algae cultivated in a controlled photobioreactor environment.

In another aspect, the metal ions are reduced in a batch process with controlled residence time.

In another aspect, the substantially single-metal crystals are washed with deionized water after separation to remove residual PIMIRS.

In another aspect, the pH is maintained within a range of about 1.5 to about 4.0 throughout the reduction process.

In another aspect, the PIMIRS are added in multiple doses to maintain optimal reduction kinetics.

In another aspect, a surface-modifying agent includes a biocompatible polymer that forms a coating on the PIMIRS, enhancing their adsorptive capabilities.

In another aspect, the method further includes a step of controlled agitation to facilitate uniform dispersion of PIMIRS in a metal ion solution during testing of their adsorptive performance.

In another aspect, the method includes a subsequent step of gentle heating to accelerate crystallization of metal ions adsorbed onto the PIMIRS during evaluation of their performance.

In another aspect, treated PIMIRS are recycled through a regeneration process that restores their adsorptive capacity without significant loss of functionality.

In another aspect, the algae are cultivated in a photobioreactor that optimizes light and nutrient conditions to enhance production of PIMIRS.

In another aspect, purified PIMIRS are tested for metal ion reduction efficacy before being packaged for use.

In another aspect, the method further includes freeze-drying purified PIMIRS to create a stable, easily transportable powder form.

In another aspect, a method for preparing a metal ion reductant from algae includes cultivating a specified algae species having metal-reducing properties, harvesting the cultivated algae at a growth stage optimized for metal ion reduction capabilities, and processing the harvested algae to extract cell walls and membranes while preserving their metal-reducing properties.

In another aspect, the algae are cultivated in a controlled aquatic system that allows precise adjustment of light, temperature, and nutrient levels.

In another aspect, the PIMIRS product is conditioned by adjusting its pH to a range that optimizes its activity in a metal ion reduction process.

In another aspect, the PIMIRS are tested in a pilot metal reduction process to optimize their composition and concentration for specific types of metal ion solutions.

In another aspect, stability of the PIMIRS is enhanced through lyophilization, ensuring that they retain metal ion reduction capabilities under various storage conditions.

In another aspect, the method includes a step of controlled drying that preserves electron transfer properties of the PIMIRS while extending their shelf life.

In another aspect, the method further includes a purification step that removes impurities from the PIMIRS, ensuring that predominantly active components are used in metal reduction processes.

In another aspect, the algae are grown in a medium enriched with trace metals to enhance their metal-binding capacity.

In another aspect, the harvesting is timed to coincide with peak expression of metal-reducing enzymes.

In another aspect, the processing includes mechanical disruption of cell walls to release intracellular metal-binding components.

In another aspect, the extracted cell walls and membranes are washed with a buffer solution to remove residual growth medium.

In another aspect, the PIMIRS are concentrated by ultrafiltration to increase their activity per unit volume.

In another aspect, the PIMIRS are formulated with a cryoprotectant before freeze-drying.

In another aspect, the algae are cultivated under stress conditions to induce production of metal-binding proteins.

In another aspect, the PIMIRS are tested for batch-to-batch consistency using a standardized metal reduction assay.

In another aspect, the PIMIRS are packaged in an inert atmosphere to prevent oxidative degradation.

In another aspect, the algae are genetically selected for enhanced metal-reducing properties.

In another aspect, the processing includes enzymatic digestion to selectively isolate active metal-binding fractions.

In another aspect, the PIMIRS are formulated with a dispersant to prevent aggregation in aqueous solutions.

In another aspect, the PIMIRS are characterized by electron microscopy to verify structural integrity.

In another aspect, a method for regenerating PIMIRS for reuse in metal ion reduction processes includes removing PIMIRS from a reaction mixture after completion of a metal reduction process, and reintroducing the regenerated PIMIRS into a new metal ion reduction process.

In another aspect, the PIMIRS are treated thermally or chemically to enhance their reactivity before reintroduction into a metal reduction process.

In another aspect, the method further includes testing a metal ion reduction capability of regenerated PIMIRS to ensure consistency in performance.

In another aspect, a regeneration process is automated and controlled by a feedback system that adjusts a treatment based on real-time performance data of the PIMIRS.

In another aspect, regenerated PIMIRS demonstrate a reduction efficiency of at least about 90% of an initial reduction capacity.

In another aspect, regenerated PIMIRS demonstrate a reduction efficiency of at least about 99% of an initial reduction capacity.

In another aspect, the regeneration process includes washing the PIMIRS with a mild acid solution to remove adsorbed metal ions.

In another aspect, the regenerated PIMIRS are reactivated by exposure to a reducing environment.

In another aspect, the regeneration cycle is repeated at least five times without significant loss of activity.

In another aspect, parameters adjusted during a regeneration process include temperature and contact time.

In another aspect, the regeneration process is monitored using spectroscopic techniques to assess restoration of active sites.

In another aspect, the PIMIRS are regenerated in situ without removal from the reaction vessel.

In another aspect, the regeneration includes a thermal treatment step to restore electron transfer capacity.

In another aspect, the regenerated PIMIRS are tested for metal selectivity before reuse.

In another aspect, the regeneration process includes pH cycling to desorb bound metal ions.

In another aspect, the PIMIRS are regenerated using an electrochemical process.

In another aspect, the regeneration efficiency is enhanced by ultrasonic treatment.

In another aspect, the regenerated PIMIRS are stored in a stabilizing buffer solution.

In another aspect, the regeneration process is optimized based on the type of metal ions previously reduced.

In another aspect, the PIMIRS are regenerated by exposure to a chelating agent that removes bound metals.

In another aspect, the regeneration includes a washing step with deionized water.

In another aspect, the regenerated PIMIRS are characterized by infrared spectroscopy to confirm restoration of functional groups.

In another aspect, the regeneration process is automated and controlled by a programmable logic controller.

In another aspect, the PIMIRS are regenerated in a continuous flow system.

In another aspect, the regeneration includes a step of enzymatic treatment to restore biological activity.

In another aspect, the regenerated PIMIRS demonstrate consistent performance over at least ten regeneration cycles.

In another aspect, the regeneration process includes a drying step to remove residual moisture.

In another aspect, the PIMIRS are regenerated using a combination of chemical and thermal treatments.

In another aspect, the regeneration efficiency is monitored using electrochemical impedance spectroscopy.

In another aspect, the regenerated PIMIRS are blended with fresh PIMIRS to maintain optimal activity.

In another aspect, the regeneration process is tailored to the specific metal ions being recovered.

In another aspect, the PIMIRS are regenerated by exposure to a reducing sugar solution.

In another aspect, a method for preparing PIMIRS for use in metal recovery includes cultivating Galdieria sulphuraria under controlled conditions to achieve optimal biomass, harvesting the biomass and extracting cell wall components known for their metal-binding properties, and treating the extracted components with a stabilization agent to enhance their shelf-life and electron transfer capabilities.

In another aspect, a method for recovering metals using PIMIRS includes introducing PIMIRS into a solution containing dissolved metal ions, adjusting the pH of the solution to optimize the reduction potential of the metal ions, allowing sufficient time for PIMIRS to bind and reduce the metal ions to their elemental or oxide forms, separating the metal-loaded PIMIRS from the solution, and recovering the metals from PIMIRS through a gentle desorption process that preserves the integrity of both the metals and PIMIRS.

In another aspect, the controlled conditions for cultivating Galdieria sulphuraria include specific light, temperature, and nutrient parameters selected based on predetermined growth curves.

In another aspect, pH adjustment is achieved using a controlled titration system that automatically maintains the pH within a target range throughout a metal recovery process.

In another aspect, the desorption process uses a mild acid wash that does not damage the PIMIRS structure.

In another aspect, the method further includes a step of enzymatic treatment to partially degrade cell walls of Galdieria sulphuraria, enhancing exposure of active metal-binding sites.

In another aspect, the method further includes a step of ultrasonic agitation during a metal binding phase to increase interaction between PIMIRS and metal ions.

In another aspect, recovered metals are further purified using a secondary filtration process that removes residual impurities.

In another aspect, the stabilization agent includes an antioxidant that prevents degradation of metal-binding sites.

In another aspect, the PIMIRS are formulated with a pH buffer to maintain stability during storage.

In another aspect, the cell wall components are extracted using a solvent-free mechanical process.

In another aspect, the PIMIRS are tested for metal-binding capacity using inductively coupled plasma mass spectrometry.

In another aspect, the biomass is harvested at a growth phase that maximizes polysaccharide content.

In another aspect, the PIMIRS are formulated in a powder form for ease of transport and storage.

In another aspect, the controlled conditions include maintaining a specific carbon-to-nitrogen ratio in the growth medium.

In another aspect, the PIMIRS are characterized by nuclear magnetic resonance spectroscopy to identify active functional groups.

In another aspect, the extraction process includes a step of enzymatic hydrolysis to enhance yield.

In another aspect, the PIMIRS are formulated with a surfactant to improve dispersion in aqueous solutions.

In another aspect, the biomass is dried using a spray-drying process to preserve activity.

In another aspect, the PIMIRS are tested for stability under various pH and temperature conditions.

In another aspect, the cell wall components are purified using chromatographic techniques.

In another aspect, the PIMIRS are formulated with a binding enhancer that increases affinity for rare earth elements.

In another aspect, the cultivation includes periodic nutrient supplementation to maintain optimal growth.

In another aspect, the PIMIRS are packaged in moisture-resistant containers to extend shelf life.

In another aspect, the extraction process is optimized to maximize recovery of electron-donating functional groups.

In another aspect, the PIMIRS are formulated with a preservative to prevent microbial contamination.

In another aspect, the biomass is harvested using a continuous flow system to maintain productivity.

In another aspect, the PIMIRS are tested for reproducibility across multiple production batches.

In another aspect, the cell wall components are treated with a cross-linking agent to enhance structural stability.

In another aspect, the PIMIRS are formulated with a metal ion scavenger to prevent premature reduction during storage.

In another aspect, the cultivation conditions are monitored using automated sensors for real-time optimization.

In another aspect, the PIMIRS are characterized by thermogravimetric analysis to assess thermal stability.

In another aspect, a system for rapid metal ion reduction includes a reaction vessel configured to contain an aqueous solution of metal ions, a delivery system for introducing PIMIRS into the reaction vessel, a pH control system designed to adjust and maintain the pH of the solution at an optimal level for rapid metal ion reduction, and a separation unit for isolating substantially single-metal crystals selected from metal crystals, metal-oxide crystals, and metal-hydroxide crystals from the solution post-reaction.

In another aspect, the PIMIRS are derived from the algae species Galdieria sulphuraria.

In another aspect, the separation unit includes a filtration system capable of filtering particles down to 1 micron in size.

In another aspect, the delivery system is configured to introduce PIMIRS in a controlled manner based on the concentration of metal ions in the solution.

In another aspect, the pH control system includes sensors for real-time monitoring of the solution's pH.

In another aspect, a system for cost-effective metal ion reduction includes a reaction vessel equipped with PIMIRS, and a control system designed to optimize the use of PIMIRS and minimize waste.

In another aspect, the system further includes a recovery and regeneration module including a filtration system that separates spent PIMIRS from substantially single-metal crystals selected from metal crystals, metal-oxide crystals, and metal-hydroxide crystals, allowing for efficient regeneration.

In another aspect, the control system utilizes real-time monitoring of reaction parameters to adjust the process dynamically.

In another aspect, a system for efficient metal ion reduction includes a reaction vessel configured to receive an aqueous solution and PIMIRS, a pH adjustment mechanism that automatically sets and maintains the optimal pH for metal ion reduction, and a single-step separation unit designed to isolate high-purity, single-metal crystals, or metal-oxide crystals, or metal-hydroxide crystals from the reaction mixture without multiple washing or purification stages.

In another aspect, the single-step separation unit utilizes gravity filtration.

In another aspect, the system includes an integrated monitoring system that automatically adjusts the amount of PIMIRS based on real-time analysis of metal ion reduction progress.

In another aspect, a dosage control system is automated and adjusts the amount of PIMIRS based on real-time feedback from the reaction process.

In another aspect, the reaction vessel is equipped with sensors and automation technology to ensure optimal conditions and minimize unnecessary resource use.

In another aspect, a PIMIRS system configured to adapt automatically to varying metal ion concentrations in industrial effluents includes sensor arrays that detect changes in metal ion concentrations in real-time, and a control unit programmed to adjust the PIMIRS dosage automatically based on the sensor data to maintain optimal metal recovery efficiency.

In another aspect, the sensor arrays include specific sensors for precious metals, enabling targeted recovery operations in mixed metal waste streams.

In another aspect, the system further includes a feedback mechanism that records performance data and adjusts operational parameters to improve future recovery processes.

In another aspect, the system has a modular design that allows for integration into existing waste treatment facilities.

In another aspect, the system includes a user interface that provides real-time analytics and control options to operators.

In another aspect, a system for the integrated application of PIMIRS in industrial settings includes a dosing unit that automatically administers PIMIRS into processing streams, a monitoring unit equipped with sensors for real-time analysis of metal ion reduction, and a control unit that processes data from the monitoring unit and adjusts the PIMIRS dosing rate accordingly.

In another aspect, the dosing unit includes a mixing chamber where PIMIRS are pre-mixed with a portion of a processing stream to ensure uniform distribution before introduction to a main stream.

In another aspect, the monitoring unit includes spectrophotometric sensors capable of detecting specific wavelengths associated with target metal ions.

In another aspect, the system is configured to integrate with existing industrial control systems using standard communication protocols, allowing for seamless operation within broader manufacturing processes.

In another aspect, the processing unit includes a counter-current extraction system to maximize a yield of PIMIRS from algae biomass.

In another aspect, a system for preparing PIMIRS from algae includes a cultivation module designed to grow algae in an optimized nutrient environment, a processing unit for extracting and isolating active components from the algae, a formulation unit that combines the active components with stabilizers and carriers to produce a ready-to-use PIMIRS product, and a quality control module to ensure the consistency and efficacy of the PIMIRS product.

In another aspect, the formulation unit is capable of producing PIMIRS in forms including powders, pellets, or liquid solutions.

In another aspect, a system for large-scale industrial application of PIMIRS includes a modular cultivation unit scalable according to production needs, a high-capacity processing unit equipped with advanced extraction and formulation technologies, and an application unit designed for efficient integration of PIMIRS into various industrial metal recovery setups.

In another aspect, the application unit includes adjustable dosing systems that can be calibrated for different types of metal recovery operations, including mining effluents and electronic waste recycling.

In another aspect, the modular cultivation unit is expandable horizontally or vertically to scale production based on demand and available space.

In another aspect, a system for optimized process control in the production and use of PIMIRS includes a central control unit equipped with software capable of processing input from multiple sensors and executing control actions, an array of sensors distributed throughout the cultivation, extraction, and application units to continuously gather data, and actuators linked to the control unit to adjust environmental conditions and process flows automatically.

In another aspect, the software includes machine learning algorithms that optimize process parameters based on historical performance data.

In another aspect, the actuators include pumps, valves, and mixers that can be adjusted in real time to change flow rates, mixing intensity, and other process parameters.

In another aspect, the sensors include optical sensors that monitor turbidity and color changes in the solution.

In another aspect, spill containment features include secondary containment barriers and automated shut-off valves that activate in response to leak detection.

In another aspect, the monitoring system is linked to an automated dosing controller that adjusts a flow of PIMIRS based on real-time water quality data.

In another aspect, the system includes a backup power supply to ensure continuous operation during power interruptions.

In another aspect, the reaction vessel is constructed from corrosion-resistant materials suitable for acidic and alkaline environments.

In another aspect, the system includes a heat exchanger to maintain optimal reaction temperature.

In another aspect, the system is configured for modular expansion to increase processing capacity.

In another aspect, the reactor is configured as a fluidized bed to enhance contact between a metal-laden solution and immobilized PIMIRS, thereby increasing an efficiency of metal recovery.

In another aspect, the system includes a programmable control unit that adjusts flow rates and contact times based on a concentration of metal ions in an incoming solution, thereby dynamically optimizing a metal recovery process.

In another aspect, the system includes a data logging module that records all process parameters for quality assurance and regulatory compliance.

In another aspect, the system is equipped with safety interlocks that prevent operation under unsafe conditions.

In another aspect, “substantially single-metal crystals” means that a single metal species constitutes at least about 95% by weight of each crystal.

In another aspect, the single metal species constitutes at least about 99% by weight of each crystal.

In another aspect, an article of manufacture includes substantially single-metal crystals selected from metal crystals, metal-oxide crystals, and metal-hydroxide crystals produced by the reduction of metal ions using PIMIRS.

In another aspect, the substantially single-metal crystals are comprised of REEs.

In another aspect, the substantially single-metal crystals have a purity level suitable for use in electronic devices.

In another aspect, the substantially single-metal crystals are formed within 24 hours of adding PIMIRS to a metal ion solution.

In another aspect, the substantially single-metal crystals are used in fabrication of magnets.

In another aspect, the substantially single-metal crystals are used in purification of water.

In another aspect, the substantially single-metal crystals are used in catalytic processes.

In another aspect, a method for producing hydrogen includes providing a solution containing at least one element selected from Group 1 and Group 2 of the periodic table, adjusting the pH of the solution, adding PIMIRS to the solution, precipitating a solid hydroxide of the at least one element from the solution, and releasing hydrogen gas.

In another aspect, the at least one element includes barium. In another aspect, the at least one element includes sodium. In another aspect, adjusting the pH of the solution includes increasing the pH to an alkaline level.

In another aspect, the PIMIRS include nanostructures. In another aspect, the nanostructures include metal oxide nanoparticles.

In another aspect, the method further includes collecting the released hydrogen gas.

In another aspect, the method further includes separating the solid hydroxide from the solution.

In another aspect, a method for generating hydrogen using PIMIRS includes preparing an aqueous solution containing a Group 1 or Group 2 element, modifying the pH of the aqueous solution, introducing PIMIRS into the aqueous solution, inducing precipitation of a hydroxide of the Group 1 or Group 2 element, and producing hydrogen gas as a result of the precipitation.

In another aspect, the Group 1 or Group 2 element includes barium.

In another aspect, the Group 1 or Group 2 element includes sodium.

In another aspect, modifying the pH includes raising the pH to a basic level.

In another aspect, the PIMIRS include nanoscale structures.

In another aspect, the nanoscale structures include metal oxide nanoparticles.

In another aspect, the method further includes harvesting the produced hydrogen gas.

In another aspect, a method of utilizing PIMIRS for hydrogen production includes forming a solution containing at least one alkali metal or alkaline earth metal, adjusting the solution to a target pH, dispersing PIMIRS in the solution, facilitating formation of a metal hydroxide precipitate, and liberating hydrogen gas concurrent with the formation of the metal hydroxide precipitate.

In another aspect, the at least one alkali metal or alkaline earth metal includes barium. In another aspect, the at least one alkali metal or alkaline earth metal includes sodium.

In another aspect, adjusting the solution to a target pH includes increasing the pH to an alkaline value.

In another aspect, the PIMIRS include nanoparticles.

In another aspect, a system for producing hydrogen gas includes a reaction vessel configured to contain a solution including at least one element selected from Group 1 and Group 2 of the periodic table, a pH adjustment mechanism configured to adjust the pH of the solution, a PIMIRS delivery mechanism configured to add PIMIRS to the solution, and a gas collection mechanism configured to collect hydrogen gas released from the reaction vessel.

In another aspect, the system further includes a solid-liquid separation mechanism configured to separate precipitated solid hydroxide from the solution.

In another aspect, the PIMIRS delivery mechanism includes a dispenser for dispensing PIMIRS nanoparticles.

In another aspect, the pH adjustment mechanism includes a chemical dosing unit.

In another aspect, the system further includes a light source configured to irradiate the solution containing the PIMIRS.

In another aspect, a composition for hydrogen gas production includes a solution containing at least one element selected from Group 1 and Group 2 of the periodic table, and PIMIRS dispersed in the solution.

In another aspect, the at least one element includes barium. In another aspect, the at least one element includes sodium. In another aspect, the PIMIRS include metal oxide nanoparticles. In another aspect, the solution has an alkaline pH.

In another aspect, a method for simultaneous production of hydrogen gas and metal hydroxide includes preparing a solution containing at least one metal ion selected from Group 1 and Group 2 of the periodic table, introducing PIMIRS into the solution, irradiating the solution containing the PIMIRS, and collecting hydrogen gas evolved from the solution while a metal hydroxide precipitates.

In another aspect, the metal ion is selected from the group consisting of barium ions and sodium ions.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A composition for selective metal recovery comprising:
a material derived from living or dead cells, cell fragments, or surface layers of living or dead cells of an alga;
wherein, upon contact of the material with a metal-ion-containing aqueous solution, one or more metals from the solution are recovered in the form of substantially single-metal crystals selected from metal crystals, metal-oxide crystals, and metal-hydroxide crystals, the crystals being initially adsorbed to the living or dead cells or cell fragments or the surface layer of the living or dead cells, and being naturally desorbed from the living or dead cells or cell fragments or the surface layer of the living or dead cells without use of a desorption reagent once the crystals reach a critical size.

2. The composition of claim 1, wherein the alga belongs to the order Cyanidiales.

3. The composition of claim 2, wherein the alga is Galdieria sulphuraria.

4. The composition of claim 1, wherein the composition selectively recovers one or more rare earth elements.

5. The composition of claim 1, wherein the composition selectively recovers one or more noble metals.

6. The composition of claim 1, wherein the composition selectively recovers one or more transition metals.

7. The composition of claim 1, wherein each substantially single-metal crystal comprises at least about 95% by weight of a single metal species.

8. The composition of claim 7, wherein the single metal species constitutes at least about 99% by weight of each crystal.

9. The composition of claim 1, wherein the critical size is in a range from about 10 microns to about 50 microns.

10. The composition of claim 1, wherein, upon contact of the material with a metal-ion-containing aqueous solution, the material facilitates electron transfer to metal ions in the solution, reducing the metal ions to form substantially single-metal crystals.

11. A formulation of Plant Induced Metal Ion Reductants (PIMIRS) for selective recovery of metals from aqueous solution, comprising:
a base composition comprising biologically derived material obtained from algae and containing cell walls, membranes, or surface layers having affinity for metal ions; and
one or more pH-adjusting agents configured to establish and maintain a pH range suitable for reduction of metal ions to substantially single-metal crystals selected from metal crystals, metal-oxide crystals, and metal-hydroxide crystals.

12. The formulation of claim 11, wherein the base composition is derived from algae of the order Cyanidiales.

13. The formulation of claim 12, wherein the algae are Galdieria sulphuraria.

14. The formulation of claim 11, further comprising one or more buffering agents configured to maintain the aqueous solution within an optimal pH range for metal recovery.

15. The formulation of claim 11, wherein the biologically derived material containing cell walls, membranes, or surface layers comprises electron transfer capability for reducing metal ions.

16. A method for recovering metal from an aqueous metal-ion-containing solution, comprising:
contacting the solution with a material derived from living or dead cells, cell fragments, or surface layers of living or dead cells of an alga;
adjusting a pH of the solution to a range suitable for metal ion reduction;
allowing metal ions to reduce and form substantially single-metal crystals selected from metal crystals, metal-oxide crystals, and metal-hydroxide crystals, the crystals being initially adsorbed to the material and naturally desorbing from the material without use of a desorption reagent once the crystals reach a critical size; and
separating the desorbed crystals from the solution.

17. The method of claim 16, wherein the alga belongs to the order Cyanidiales.

18. The method of claim 16, wherein the recovering comprises selectively recovering one or more rare earth elements.

19. The method of claim 16, wherein each substantially single-metal crystal comprises at least about 95% by weight of a single metal species.

20. The method of claim 16, wherein the substantially single-metal crystals have an average size in a range from about 20 microns to about 40 microns.
